(19) United States
(12) Patent Application Publication
(10) Pub. No.: US 2024/0187929 A1
(43) Pub. Date: Jun. 6, 2024

(54) METHODS FOR REVOKING INTER-DONOR TOPOLOGY ADAPTATION IN INTEGRATED ACCESS AND BACKHAUL NETWORKS

(71) Applicant: Telefonaktiebolaget LM Ericsson (publ), Stockholm (SE)

(72) Inventors: Filip BARAC, HUDDINGE (SE); Marco BELLESCHI, SOLNA (SE); Ritesh SHREEVASTAV, UPPLANDS VÄSBY (SE); Jose Luis PRADAS, STOCKHOLM (SE)

(21) Appl. No.: 18/556,127

(22) PCT Filed: Apr. 20, 2022
(86) PCT No.: PCT/SE2022/050385

§ 371 Date: Oct. 19, 2023

Related U.S. Application Data
(60) Provisional application No. 63/176,937, filed on Apr. 20, 2021.

(51) Int. Cl. H04W 28/086

(52) U.S. Cl. CPC H04W 28/086

(57) ABSTRACT

A method (1800) by a network node (160) operating as a first donor node for a wireless device (110) includes transmitting (1802), to the second donor node (160), a first message requesting a revocation of traffic offloading from the first donor node to the second donor node. Likewise, a network node (160) operating as the second donor node receives the first message requesting the revocation of traffic offloading from the first donor node to the second donor node.

### TECHNICAL FIELD

The present disclosure relates, in general, to wireless communications and, more particularly, systems and methods for revoking inter-donor topology adaptation in Integrated Access and Backhaul networks.

### BACKGROUND

3^{rd} Generation Partnership Project (3GPP) has completed the integrated access and wireless access backhaul in New Radio (IAB) Rel-16 and is currently standardizing the IAB Rel-17.

The usage of short range mmWave spectrum in New Radio (NR) creates a need for densified deployment with multi-hop backhauling. However, optical fiber to every base station will be too costly and sometimes not even possible (e.g. historical sites). The main IAB principle is the use of wireless links for the backhaul (instead of fiber) to enable flexible and very dense deployment of cells without the need for densifying the transport network. Use case scenarios for IAB can include coverage extension, deployment of massive number of small cells and fixed wireless access (FWA) (e.g. to residential/office buildings). The larger bandwidth available for NR in mmWave spectrum provides opportunity for self-backhauling, without limiting the spectrum to be used for the access links. On top of that, the inherent multi-beam and Multiple Input-Multiple Output (MIMO) support in NR reduce cross-link interference between backhaul and access links allowing higher densification.

During the study item phase of the IAB work, which is summarized in TR 38.874, it has been agreed to adopt a solution that leverages the Central Unit (CU)/Distributed Unit (DU) split architecture of NR, where the IAB node will be hosting a DU part that is controlled by a central unit. The IAB nodes also have a Mobile Termination (MT) part that they use to communicate with their parent nodes.

The specifications for IAB strives to reuse existing functions and interfaces defined in NR. In particular, MT, gNodeB-DU (gNB-DU), gNodeB-CU (gNB-CU), User Plane Function (UPF), Applications Management Function (AMF), and Sessions Management Function (SMF) as well as the corresponding interfaces NR Uu (between MT and gNodeB (gNB)), F1, Next Generation (NG), X2 and N4 are used as baseline for the IAB architectures. Modifications or enhancements to these functions and interfaces for the support of IAB will be explained in the context of the architecture discussion. Additional functionality such as multi-hop forwarding is included in the architecture discussion as it is necessary for the understanding of IAB operation and since certain aspects may require standardization.

The MT function has been defined as a component of the IAB node. In the context of this study, MT is referred to as a function residing on an IAB-node that terminates the radio interface layers of the backhaul Uu interface toward the IAB-donor or other IAB-nodes.

FIG. 1 illustrates a high-level architectural view of an IAB network, according to 3GPP TR 38.874, which contains one IAB-donor and multiple IAB-nodes. The IAB-donor is treated as a single logical node that comprises a set of functions such as gNB-DU, gNB-CU-Control Plane (gNB-CU-CP), gNB-CU-User Plane (gNB-CU-UP) and potentially other functions. In a deployment, the IAB-donor can be split according to these functions, which can all be either collocated or non-collocated as allowed by 3GPP Next Generation-Radio Access Network (NG-RAN) architecture. IAB-related aspects may arise when such split is exercised. Also, some of the functions presently associated with the IAB-donor may eventually be moved outside of the donor in case it becomes evident that they do not perform IAB-specific tasks.

The baseline user plane (UP) and control plane (CP) protocol stacks for IAB in Rel-16 are shown in FIGS. 2 and 3. As depicted, the chosen protocol stacks reuse the current CU-DU split specification in Rel-15, where the full user plane F1-U (General Packet Radio Service Tunneling Protocol (GTP-U)/User Data Plane (UDP)/Internet Protocol (IP)) is terminated at the IAB node (like a normal DU) and the full control plane F1-C (F1 Application Protocol (F1-AP)/Stream Control Transmission Protocol (SCTP)/IP) is also terminated at the IAB node (like a normal DU). In the above cases, Network Domain Security (NDS) has been employed to protect both UP and CP traffic (IP security (IPsec) in the case of UP, and DTLS in the case of CP). IPsec could also be used for the CP protection instead of DTLS (in this case no DTLS layer would be used).

A new protocol layer called Backhaul Adaptation Protocol (BAP) has been introduced in the IAB nodes and the IAB donor, which is used for routing of packets to the appropriate downstream/upstream node and also mapping the user equipment (UE) bearer data to the proper backhaul Radio Link Control (RLC) channel (and also between ingress and egress backhaul RLC channels in intermediate IAB nodes) to satisfy the end-to-end Quality of Service (QoS) requirements of bearers. Therefore, the BAP layer is in charge of handling the backhaul (BH) RLC channel, e.g. to map an ingress BH RLC channel from a parent/child IAB node to an egress BH RLC channel in the link towards a child/parent IAB node. In particular, one BH RLC channel may conveys end-user traffic for several data radio bearers (DRBs) and for different UEs which could be connected to different IAB nodes in the network. In 3GPP two possible configuration of BH RLC channel has been provided. First, a 1:1 mapping is provided between BH RLC channel and a specific user's DRB. Second, a N:1 bearer mapping is provided where N DRBs possibly associated to different UEs are mapped to 1 BH RLC channel. The first case can be easily handled by the IAB node's scheduler since there is a 1:1 mapping between the QoS requirements of the BH RLC channel and the QoS requirements of the associated DRB. However, this type of 1:1 configuration is not easily scalable in case an IAB node is serving many UEs/DRBs. On the other hand, the N:1 configuration is more flexible/scalable, but ensuring fairness across the various served BH RLC channels might be trickier, because the amount of DRBs/UEs served by a given BH RLC channel might be different from the amount of DRBs/UEs served by another BH RLC channel.

On the IAB-node, the BAP sublayer contains one BAP entity at the MT function and a separate co-located BAP entity at the DU function. On the IAB-donor-DU, the BAP sublayer contains only one BAP entity. Each BAP entity has a transmitting part and a receiving part. The transmitting part of the BAP entity has a corresponding receiving part of a BAP entity at the IAB-node or IAB-donor-DU across the backhaul link.

FIG. 4 illustrates one example of the functional view of the BAP sublayer. This functional view should not restrict implementation. FIG. 4 is based on the radio interface protocol architecture defined in 3GPP TS 38.300. In the example of FIG. 4, the receiving part on the BAP entity delivers BAP Protocol Data Units (PDUs) to the transmitting part on the collocated BAP entity. Alternatively, the receiving part may deliver BAP Service Data Units (SDUs) to the collocated transmitting part. When passing BAP SDUs, the receiving part removes the BAP header, and the transmitting part adds the BAP header with the same BAP routing identifier (ID) as carried on the BAP PDU header prior to removal. Passing BAP SDUs in this manner is therefore functionally equivalent to passing BAP PDUs, in implementation.

The following services are provided by the BAP sublayer to upper layers: data transfer. A BAP sublayer expects the following services from lower layers per RLC entity (for a detailed description see 3GPP TS 38.322): acknowledged data transfer service and unacknowledged data transfer service.

The BAP sublayer supports the following functions:
Data transfer;
Determination of BAP destination and path for packets from upper layers;
Determination of egress BH RLC channels for packets routed to next hop;
Routing of packets to next hop;
Differentiating traffic to be delivered to upper layers from traffic to be delivered to egress link; and
Flow control feedback and polling signalling;

Therefore, the BAP layer is fundamental to determine how to route a received packet. For the downstream that implies determining whether the packet has reached its final destination, in which case the packet will be transmitted to UEs that are connected to this IAB node as access node, or to forward it to another IAB node in the right path. In the first case, the BAP layer passes the packet to higher layers in the IAB node which are in charge of mapping the packet to the various QoS flows and, thus, DRBs which are included in the packet. In the second case, the BAP layer instead determines the proper egress BH RLC channel on the basis of the BAP destination, path IDs, and ingress BH RLC channel. Same as the above applies also to the upstream, with the only difference that the final destination is always one specific donor DU/CU.

In order to achieve the above tasks, the BAP layer of the IAB node has to be configured with a routing table mapping ingress RLC channels to egress RLC channels which may be different depending on the specific BAP destination and path of the packet. Hence, the BAP destination and path ID are included in the header of the BAP packet so that the BAP layer can determine where to forward the packet.

Additionally, the BAP layer has an important role in the hop-by-hop flow control. In particular a child node can inform the parent node about possible congestions experienced locally at the child node, so that the parent node can throttle the traffic towards the child node. The parent node can also use the BAP layer to inform the child a node in case of Radio Link Failure (RLF) issues experienced by the parent, so that the child can possibly reestablish its connection to another parent node.

Topology adaptation in IAB networks may be needed for various reasons such as, for example, changes in the radio conditions, changes to the load under the serving CU, radio link failures, etc. The consequence of an IAB topology adaptation could be that an IAB node is migrated (i.e. handed-over) to a new parent (which can be controlled by the same or different CU) or that some traffic currently served by such IAB node is offloaded via a new route (which can be controlled by the same or different CU). If the new parent of the IAB node is under the same CU or a different CU, the migration is intra-donor and inter-donor one, respectively (herein also referred to as the intra-CU and inter-CU migration).

FIG. 5 illustrates an example of some possible IAB-node migration (i.e. topology adaptation) cases listed in the order of complexity.

As illustrated in FIG. 5, in the Intra-CU Case (A), the IAB-node (e) along with it serving UEs is moved to a new parent node (IAB-node (b)) under the same donor-DU (1). The successful intra-donor DU migration requires establishing UE context setup for the IAB-node (e) MT in the DU of the new parent node (IAB-node (b)), updating routing tables of IAB nodes along the path to IAB-node (e) and allocating resources on the new path. The IP address for IAB-node (e) will not change, while the F1-U tunnel/connection between donor-CU (1) and IAB-node (e) DU will be redirected through IAB-node (b).

The procedural requirements/complexity of Intra-CU Case (B) is the same as that of Case (A). Also, since the new IAB-donor DU (i.e., DU2) is connected to the same Layer 2 (L2) network, the IAB-node (e) can use the same IP address under the new donor DU. However, the new donor DU (i.e. DU2) will need to inform the network using IAB-node (e) L2 address in order to get/keep the same JP address for IAB-node (e) by employing some mechanism such as Address Resolution Protocol (ARP).

The Intra-CU Case (C) is more complex than Case (A) as it also needs allocation of new IP address for IAB-node (e). In this case, IPsec is used for securing the F1-U tunnel/connection between the Donor-CU (1) and IAB-node (e) DU, then it might be possible to use existing IP address along the path segment between the Donor-CU (1) and SeGW, and new IP address for the IPsec tunnel between SeGW and IAB-node (e) DU.

Inter-CU Case (D) is the most complicated case in terms of procedural requirements and may needs new specification procedures (such as enhancement of RRC, F1AP, XnAP, Ng signaling) that are beyond the scope of 3GPP Rel-16.3GPP Rel-16 specifications only consider procedures for intra-CU migration. Inter-CU migration requires new signalling procedures between source and target CU in order to migrate the IAB node contexts and its traffic to the target CU, such that the IAB node operations can continue in the target CU and the QoS is not degraded. Inter-CU migration will be specified in the context of 3GPP Rel-17.

During the intra-CU topology adaptation, both the source and the target parent node are served by the same IAB-donor-CU. The target parent node may use a different IAB-donor-DU than the source parent node. The source path may further have common nodes with the target path. FIG. 6 illustrates an example of the IAB Intra-CU topology adaptation procedure, where the target parent node uses a different IAB-donor-DU than the source parent node. As depicted, the procedure includes:
1. The migrating IAB-MT sends a MeasurementReport message to the source parent node IAB-DU. This report is based on a Measurement Configuration the migrating IAB-MT received from the IAB-donor-CU before.
2. The source parent node IAB-DU sends an UL RRC MESSAGE TRANSFER message to the IAB-donor-CU to convey the received MeasurementReport.
3. The IAB-donor-CU sends a UE CONTEXT SETUP REQUEST message to the target parent node IAB-DU to create the UE context for the migrating IAB-MT and set up one or more bearers. These bearers can be used by the migrating IAB-MT for its own signalling, and, optionally, data traffic.
4. The target parent node IAB-DU responds to the IAB-donor-CU with a UE CONTEXT SETUP RESPONSE message.
5. The IAB-donor-CU sends a UE CONTEXT MODIFICATION REQUEST message to the source parent node IAB-DU, which includes a generated RRCReconfiguration message. The RRCReconfiguration message includes a default BH RLC channel and a default BAP Routing ID configuration for UL F1-C/non-F1 traffic mapping on the target path. It may include additional BH RLC channels. This step may also include allocation of TNL address(es) that is (are) routable via the target IAB-donor-DU. The new TNL address(es) may be included in the RRCReconfiguration message as a replacement for the TNL address(es) that is (are) routable via the source IAB-donor-DU. In case IPsec tunnel mode is used to protect the F1 and non-F1 traffic, the allocated TNL address is outer IP address. The TNL address replacement is not necessary if the source and target paths use the same IAB-donor-DU. The Transmission Action Indicator in the UE CONTEXT MODIFICATION REQUEST message indicates to stop the data transmission to the migrating IAB-node.
6. The source parent node IAB-DU forwards the received RRCReconfiguration message to the migrating IAB-MT.
7. The source parent node IAB-DU responds to the IAB-donor-CU with the UE CONTEXT MODIFICATION RESPONSE message.
8. A Random Access procedure is performed at the target parent node IAB-DU.
9. The migrating IAB-MT responds to the target parent node IAB-DU with an RRCReconfigurationComplete message.
10. The target parent node IAB-DU sends an UL RRC MESSAGE TRANSFER message to the IAB-donor-CU to convey the received RRCReconfigurationComplete message. Also, uplink packets can be sent from the migrating IAB-MT, which are forwarded to the IAB-donor-CU through the target parent node IAB-DU. These UL packets belong to the IAB-MT's own signalling and, optionally, data traffic.
11. The IAB-donor-CU configures BH RLC channels and BAP-sublayer routing entries on the target path between the target parent IAB-node and target IAB-donor-DU as well as DL mappings on the target IAB-donor-DU for the migrating IAB-node's target path. These configurations may be performed at an earlier stage, e.g. immediately after step 3. The IAB-donor-CU may establish additional BH RLC channels to the migrating IAB-MT via RRC message.
12. The F1-C connections are switched to use the migrating IAB-node's new TNL address(es), IAB-donor-CU updates the UL BH information associated to each GTP-tunnel to migrating IAB-node. This step may also update UL FTEID and DL FTEID associated to each GTP-tunnel. All F1-U tunnels are switched to use the migrating IAB-node's new TNL address(es). This step may use non-UE associated signaling in E1 and/or F1 interface to provide updated UP configuration for F1-U tunnels of multiple connected UEs or child IAB-MTs. The IAB-donor-CU may also update the UL BH information associated with non-UP traffic. Implementation must ensure the avoidance of potential race conditions, i.e. no conflicting configurations are concurrently performed using UE-associated and non-UE-associated procedures.
13. The IAB-donor-CU sends a UE CONTEXT RELEASE COMMAND message to the source parent node IAB-DU.
14. The source parent node IAB-DU releases the migrating IAB-MT's context and responds to the IAB-donor-CU with a UE CONTEXT RELEASE COMPLETE message.
15. The IAB-donor-CU releases BH RLC channels and BAP-sublayer routing entries on the source path between source parent IAB-node and source IAB-donor-DU.

In case that the source path and target path have common nodes, the BH RLC channels and BAP-sublayer routing entries of those nodes may not need to be released in Step 15.

Steps 11, 12 and 15 should also be performed for the migrating IAB-node's descendant nodes, as follows:
The IAB-donor-CU may allocate new TNL address(es) that is (are) routable via the target IAB-donor-DU to the descendent nodes via RRCReconfiguration message.
If needed, the IAB-donor-CU may also provide a new default UL mapping which includes a default BH RLC channel and a default BAP Routing ID for UL F1-C/non-F1 traffic on the target path, to the descendant nodes via RRCReconfiguration message.
If needed, the IAB-donor-CU configures BH RLC channels, BAP-sublayer routing entries on the target path for the descendant nodes and the BH RLC channel mappings on the descendant nodes in the same manner as described for the migrating IAB-node in step 11.
The descendant nodes switch their F1-C connections and F1-U tunnels to new TNL addresses that are anchored at the new IAB-donor-DU, in the same manner as described for the migrating IAB-node in step 12.
Based on implementation, these steps can be performed after or in parallel with the handover of the migrating IAB-node.
   In upstream direction, in-flight packets between the source parent node and the IAB-donor-CU can be delivered even after the target path is established. In-flight downlink data in the source path may be discarded, up to implementation via the NR user plane protocol (3GPP TS 38.425). The IAB-donor-CU can determine the unsuccessfully transmitted downlink data over the backhaul link by implementation.

As mentioned above, 3GPP Rel-16 has standardized only intra-CU topology adaptation procedure. Considering that inter-CU migration will be an important feature of IAB Rel-17, enhancements to existing procedure are required for reducing service interruption (due to IAB-node migration) and signaling load.

Some use cases for inter-donor topology adaptation (aka inter-CU migration) are:
Inter-donor load balancing: One possible scenario is that a link between an IAB node and its parent becomes congested. In this case, the traffic of an entire network branch, below and including the said IAB node (herein referred to as the top-level IAB node) may be redirected to reach the top-level node via another route. If the new route for the offloaded traffic includes traversing the network under another donor before reaching the top-level node, the scenario is an inter-donor routing one. The offloaded traffic may include both the traffic terminated at the top-level IAB node and its served UEs, or the traffic traversing the top-level IAB node, and terminated at its descendant IAB nodes and UEs. In this case, the MT of the top-level IAB node (i.e. top-level IAB-MT) may establish an Radio Resource Control (RRC) connection to another donor (thus releasing its RRC connection to the old donor), and the traffic towards this node and its descendant devices is now sent via the new donor.
Inter-donor Radio Link Failure (RLF) recovery: An IAB node experiencing an RLF on its parent link attempts RRC reestablishment towards a new parent under another donor (this node can also be referred to as the top-level IAB node). According to 3GPP agreements, if the descendant IAB nodes and UEs of the top-level node “follow” to the new donor, the parent-child relations are retained after the top-level node connects to another donor.

The above cases assume that the top-level node's IAB-MT can connect to only one donor at a time. However, Rel-17 work will also consider the case where the top-level IAB-MT can simultaneously connect to two donors, in which case:
For load balancing, the traffic reaching the top-level IAB node via one leg may be offloaded to reach the top-level IAB node (and, potentially, its descendant nodes) via the other leg that the node established to another donor.
For RLF recovery, the traffic reaching the top-level IAB node via the broken leg can be redirected to reach the node via the “good” leg, towards the other donor.

With respect to inter-donor topology adaptation, the 3GPP Rel 17 specifications will allow two alternatives:
Proxy-based solution: Assuming that top-level IAB-MT is capable of connecting to only one donor at a time, the top-level IAB-MT migrates to a new donor, while the F1 and RRC connections of its collocated IAB-DU and all the descendant IAB-MTs, IAB-DUs and UEs remain anchored at the old donor, even after inter-donor topology adaptation.
   Proxy-based solution is also applicable in case when top-level IAB-MT is simultaneously connected to two donors. In this case, some or all of the traffic traversing/terminating at the top-level node is offloaded via the leg towards the ‘other’ donor.
Full migration-based solution: All the F1 and RRC connections of the top-level node and all its descendant devices and UEs are migrated to the new donor.
   The details of both solutions are currently under discussion in 3GPP.

One drawback of the full migration-based solution for inter-CU migration is that a new F1 connection is set up from IAB-node E to the new CU (i.e. CU(2)) and the old F1 connection to the old CU (i.e. CU(1)) is released.

Releasing and relocating the F1 connection will impact all UEs (i.e., UE_{c}, UE_{d}, and UEₑ) and any descendant IAB nodes (and their served UEs) by causing:
1. Service interruption for the UEs and IAB nodes served by the top-level IAB node (i.e., IAB-node E) since these UEs may need to re-establish their connection or to perform handover operation (even if they remain under the same IAB node, as 3GPP security principles mandate to perform key refresh whenever the serving CU/gNB is changed (e.g., at handover or reestablishment), i.e., RRC reconfiguration with reconfigurationWithSync has to be sent to each UE).
2. A signaling storm, since a large number of UEs, IAB-MTs and IAB-DUs have to perform re-establishment or handover at the same time.

In addition, it is preferred that any reconfiguration of the descendant nodes of the top-level node is avoided. This means that the descendant nodes should preferably be unaware of the fact that the traffic is proxied via CU2.

To address the above problems, a proxy-based mechanism has been proposed where the inter-CU migration is done without handing over the UEs or IAB nodes directly or indirectly being served by the top-level IAB node, thereby making the handover of the directly and indirectly served UEs transparent to the target CU. In particular, only the RRC connection of the top-level IAB node is migrated to the target CU, while the CU-side termination of its F1 connection as well as the CU-side terminations of the F1 and RRC connections of its directly and indirectly served IAB nodes and UEs are kept at the source CU. In this case, the target CU serves as the proxy for these F1 and RRC connections that are kept at the source CU. Thus, the target CU just needs to ensure that the ancestor node of the top-level IAB node are properly configured to handle the traffic from the top-level node to the target donor, and from the target donor to the top-level node. Meanwhile, the configuration of the descendant IAB node of the said top-level node are still under the control of the source donor. Thus, in this case the target donor does not need to know the network topology and the QoS requirements or the configuration of the descendant IAB nodes and UEs.

FIG. 7 illustrates an example signal flow before IAB-node 3 migration. Specifically, FIG. 7 illustrates the signalling connections when the F1 connections are maintained in the CU-1. FIG. 8 illustrates an example signal flow after IAB-node 3 migration. Specifically, FIG. 8 highlights how the F1-U is tunnelled over the Xn and then transparently forwarded to the IAB donor-DU-2 after the IAB node is migrated to the target donor CU (i.e. CU2).

FIG. 9 illustrates an example of proxy-based solution for inter-donor load balancing. Specifically, FIG. 9 illustrates an example of inter-donor load balancing scenario, involving IAB3 and its descendant node IAB4 and the UEs that these two IAB nodes are serving.

Applied to the scenario from FIG. 9, the proxy-based solution works as follows:
IAB3-MT changes its RRC connection (i.e., association) from CU_1 to CU_2.
Meanwhile, the RRC connections of IAB4-MT and all the UEs served by IAB3 and IAB4, as well as the F1 connections of IAB3-DU and IAB4-DU would remain anchored at CU_1 (i.e. they are not moved to CU_2), whereas the corresponding traffic of these connections is sent to and from the IAB3/IAB4 and their served UEs by using a path via CU_2.

So, the traffic previously sent from the source donor (i.e., CU_1 in FIG. 9) to the top-level IAB node (IAB3) and its descendants (e.g. IAB4) is offloaded (i.e. proxied) via CU_2. In particular:
The old traffic path from CU_1 to IAB4, i.e. CU_1-Donor DU_1-IAB2-IAB3-IAB4 is, for load balancing purposes, changed to CU_1-Donor DU_2-IAB5-IAB3-IAB4.

Herein, the assumption is that direct routing between CU_1 and Donor DU_2 is applied (i.e. CU_1-Donor DU_1- and so on . . . ), rather than the indirect routing case CU_1-CU_2-Donor DU_1- and so on . . . ). The direct routing can e.g. be supported via IP routing between (source donor) CU_1 and donor DU2 (target donor DU) or via an Xn connection between the two. In indirect routing, data can be sent between CU_1 and CU_2 via Xn interface, and between CU_2 and Donor DU_2 via F1 or via IP routing. Both direct and indirect routing are applicable in this disclosure.

The advantage of direct routing is that the latency is likely smaller. 3GPP TS 38.300 has defined the Dual Active Protocol Stack (DAPS) Handover procedure that maintains the source gNB connection after reception of RRC message (HO Command) for handover and until releasing the source cell after successful random access to the target gNB.

A DAPS handover can be used for an RLC-Acknowledge Mode (RLC-AM) or RLC-Unacknowledged Mode (RLC-UM) bearer. For a DRB configured with DAPS, the following principles are additionally applied for downlink:
During handover (HO) preparation, a forwarding tunnel is always established.
The source gNB is responsible for allocating downlink Packet Data Convergence Protocol (PDCP) Sequence Numbers (SNs) until the SN assignment is handed over to the target gNB and data forwarding takes place. That is, the source gNB does not stop assigning PDCP SNs to downlink packets until it receives the HANDOVER SUCCESS message and sends the SN STATUS TRANSFER message to the target gNB.
Upon allocation of downlink PDCP SNs by the source gNB, it starts scheduling downlink data on the source radio link and also starts forwarding downlink PDCP SDUs along with assigned PDCP SNs to the target gNB.
For security synchronisation, Hyper Frame Number (HFN) is maintained for the forwarded downlink SDUs with PDCP SNs assigned by the source gNB. The source gNB sends the EARLY STATUS TRANSFER message to convey the DL COUNT value, indicating PDCP SN and HFN of the first PDCP SDU that the source gNB forwards to the target gNB.
HFN and PDCP SN are maintained after the SN assignment is handed over to the target gNB. The SN STATUS TRANSFER message indicates the next DL PDCP SN to allocate to a packet which does not have a PDCP sequence number yet, even for RLC-UM.
During handover execution period, the source and target gNBs separately perform Robust Header Compression (ROHC) header compression, ciphering, and adding PDCP header.
During handover execution period, the UE continues to receive downlink data from both source and target gNBs until the source gNB connection is released by an explicit release command from the target gNB.
During handover execution period, the UE PDCP entity configured with DAPS maintains separate security and ROHC header decompression functions associated with each gNB, while maintaining common functions for reordering, duplicate detection and discard, and PDCP SDUs in-sequence delivery to upper layers. PDCP SN continuity is supported for both RLC AM and UM DRBs configured with DAPS.

For a DRB configured with DAPS, the following principles are additionally applied for uplink:
The UE transmits uplink (UL) data to the source gNB until the random access procedure toward the target gNB has been successfully completed. Afterwards, the UE switches its UL data transmission to the target gNB.
Even after switching its UL data transmissions towards the target gNB, the UE continues to send UL layer 1 Channel State Information (CSI) feedback, Hybrid Automatic Repeat Request (HARQ) feedback, layer 2 RLC feedback, ROHC feedback, HARQ data re-transmissions, and RLC data re-transmission to the source gNB.
During handover execution period, the UE maintains separate security context and ROHC header compressor context for uplink transmissions towards the source and target gNBs. The UE maintains common UL PDCP SN allocation. PDCP SN continuity is supported for both RLC AM and UM DRBs configured with DAPS.
During handover execution period, the source and target gNBs maintain their own security and ROHC header decompressor contexts to process UL data received from the UE.
The establishment of a forwarding tunnel is optional.
HFN and PDCP SN are maintained in the target gNB. The SN STATUS TRANSFER message indicates the COUNT of the first missing PDCP SDU that the target should start delivering to the 5GC, even for RLC-UM.

At the RAN3 #110-e meeting, RAN3 agreed that potential solutions for simultaneous connectivity to two donors may include a “DAPS-like” solution. In that respect, a solution referred to as the Dual IAB Protocol Stack (DIPS) has been proposed in 3GPP. FIG. 10 illustrates an example DIPS.

DIPS is based on:
Two independent protocol stacks (RLC/Medium Access Control (MAC)/Physical (PHY)), each connecting to a different CU.
One or two independent BAP entities with some common and some independent functionalities.
Each CU allocates its own resources (e.g., addresses, BH RLC channels, etc.) without the need for coordination, and configures each protocol stack.

In essence, the solution comprises two protocol stacks as in DAPS, with the difference being the BAP entity(-ies) instead of a PDCP layer. A set of BAP functions could be common, and another set of functions could be independent for each parent node.

This type of solution reduces the complexity to the minimum and achieves all the goals of the WI, since:
Each protocol stack can be configured independently using current signalling and procedures increasing robustness. Minimal signalling updates might be needed.
Only the top-level IAB node is reconfigured. Everything is transparent for other nodes and UEs which do not require any reconfiguration, resulting in decreasing signalling load and increasing robustness.
It eliminates service interruption, as data can continue flowing over the initial link until the second is set-up.
It avoids the need of IP/BAP addresses and route IDs coordination between CUs, which reduces significantly the complexity and the network signalling.

When the CU determines that load balancing is needed, the CU starts the procedure requesting to a second CU resources to offload part of the traffic of a certain (i.e. top-level) IAB node. The CUs will negotiate the configuration and the second CU will prepare the configuration to apply in the second protocol stack of the IAB-MT, the RLC backhaul channel(s), BAP address(es), etc. The top-level IAB-MT will use routing rules provided by the CU to route certain traffic to the first or the second CU. In the DL, the IAB-MT will translate the BAP addresses from the second CU to the BAP addresses from the first CU to reach the nodes under the control of the first CU. All this means that only the top-level IAB node (i.e. the IAB node from which traffic is offloaded) is affected and no other node or UE is aware of this situation. All this procedure can be performed with current signalling, with some minor changes.

RAN3 has agreed the following two scenarios for the inter-donor topology redundancy:
Scenario 1: the IAB is multi-connected with 2 Donors.
Scenario 2: the IAB's parent/ancestor node is multi-connected with 2 Donors.

FIG. 11 illustrates the scenarios for inter-donor topological redundancy. In these two scenarios, RAN3 uses the following terminologies:
Boundary IAB node: the node accesses two different parent nodes connected to two different donor CUs, respectively, e.g., IAB 3 in above figures;
Descendant IAB node: the node(s) accessing to network via boundary IAB node, and each node is single-connected to its parent node, e.g., IAB4 in scenario 2
F1-termination node: the donor CU terminating F1 interface of the boundary IAB node and descendant node(s)
Non-F1-termination node: the CU with donor functionalities, which does not terminate F1 interface of the boundary IAB node and descendant node(s)

Certain problems exist, however. For example, it is quite likely that the inter-donor topology adaptation scenarios will involve a large number of devices with a large amount of traffic to be offloaded. However, the following should be noted:
Donor CUs are not dimensioned to take over the traffic of other CUs for long periods of time.
It is likely that the causes of inter-donor topology adaptation will be short.

From the above, the ground assumption follows: long-term inter-donor offloading is neither sustainable nor necessary and a mechanism for temporary offloading needs to be enabled.

Furthermore, as explained above, topology adaptation can be accomplished by using the proxy-based solution, where, with respect to the scenario shown in FIG. 9, the top-level IAB3-MT changes its RRC connection (i.e., association) from CU_1 to CU_2. Meanwhile, the RRC connections of IAB4-MT and all the UEs served by IAB3 and IAB4, as well as the F1 connections of IAB3-DU and IAB4-DU remain anchored at CU_1, whereas the corresponding traffic of these connections would be sent to and from the IAB3/IAB4 and their served UEs by using the new path (as described above).

Nevertheless, it is expected that the need for offloading traffic to another donor would be only temporary (e.g. during peak hours of the day), and that, after a while, the traffic can be returned to the network under the first donor. It is also expected that millimeter wave links will generally be quite stable, with rare and short interruptions. In that sense, in case topology adaptation was caused by inter-donor RLF recovery, it is expected that it will be possible to establish (again) a stable link towards the (old) parent under the old donor.

Currently, it is unclear how to revoke (i.e. de-configure) the traffic offloading to another donor (e.g. by means of proxy-based approach, for both load balancing and inter-donor RLF recovery), i.e. how the traffic can be moved back from the proxied path(s) under another donor (e.g. CU_2) to its original path(s) under the first donor (e.g. CU_1).

As explained above, in the Rel-17 normative work on IAB inter-donor topology adaptation, 3GPP will also consider the case where the top-level IAB-MT is simultaneously connected to two donors. In this case, the traffic traversing/terminating at the top-level node is offloaded via the leg towards the “other” donor. At the RAN3 #110-e meeting, RAN3 agreed to discuss solutions for simultaneous connectivity to two donors, where one of the solutions discussed is a “DAPS-like” solution, and, for that purpose, as explained above, the DIPS concept was proposed and is under discussion. Consequently, if the solution for simultaneous connectivity to two donors (e.g. DIPS) is based on current DAPS, it is unclear how the traffic offloading to another CU can be revoked/deactivated.

Additionally, if the solution for simultaneous connectivity to two donors (e.g. DIPS) is based on current DAPS, it is unclear how the traffic offloading to another CU can be revoked/deactivated, i.e. how the offloaded traffic can be moved from top-level node's leg towards the second donor (e.g. CU_2), back to its original leg towards the first donor (e.g. CU_1).

It should be noted that the problem is also applicable to regular UEs configured with DAPS. In current DAPS framework, for a regular UE, the source sends the handover (HO) preparation message to the target, and target replies with HO confirmation+HO command or with a HO rejection message. So, there is no signaling for the source to bring back the UE to the source, unless the HO to the target fails.

Another problem exists. Specifically, if DAPS is used for load balancing of traffic to/from a UE, between two RAN nodes, it is unclear how the DAPS for the UE can be revoked in this case.

### SUMMARY

Certain aspects of the present disclosure and their embodiments may provide solutions to these or other challenges. For example, according to certain embodiments, methods and systems are provided for the revocation of traffic offloading to a donor node.

According to certain embodiments, a method by a network node operating as a first donor node for a wireless device includes transmitting, to the second donor node, a first message requesting a revocation of traffic offloading from the first donor node to the second donor node.

According to certain embodiments, a network node operating as a first donor node for a wireless device is adapted to transmit, to the second donor node, a first message requesting a revocation of traffic offloading from the first donor node to the second donor node.

According to certain embodiments, a method by a network node operating as a second donor node for traffic offloading for a wireless device includes receiving, from a first donor node, a first message requesting a revocation of traffic offloading from the first donor node to the second donor node.

According to certain embodiments, a network node operating as a second donor node for traffic offloading for a wireless device is adapted to receive, from a first donor node, a first message requesting a revocation of traffic offloading from the first donor node to the second donor node

Certain embodiments may provide one or more of the following technical advantages. For example, one technical advantage may be that certain embodiments proposed herein are essential for enabling temporary offloading. Thus, certain embodiments enable the network to stop the offloading and to return the traffic back to its original path as soon as the conditions are met.

Another technical advantage may be that certain embodiments help avoid failures and packet losses in case of a UE configured with DAPS that changes trajectory, thus never being handed over to the intended target.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a high-level architectural view of an IAB network, according to 3GPP TR 38.874;

FIG. 2 illustrates the baseline UP protocol stack for IAB in Rel-16;

FIG. 3 illustrates the baseline CP protocol stack for IAB in Rel-16;

FIG. 4 illustrates one example of the functional view of the BAP sublayer;

FIG. 5 illustrates an example of some possible IAB-node migration (i.e. topology adaptation) cases;

FIG. 6 illustrates an example of the IAB Intra-CU topology adaptation procedure, where the target parent node uses a different IAB-donor-DU than the source parent node;

FIG. 7 illustrates an example signal flow before IAB-node 3 migration;

FIG. 8 illustrates an example signal flow after IAB-node 3 migration;

FIG. 9 illustrates an example of proxy-based solution for inter-donor load balancing;

FIG. 10 illustrates an example DIPS;

FIG. 11 illustrates the scenarios for inter-donor topological redundancy;

FIG. 12 illustrates an example DAPS/DIPS revocation scenario;

FIG. 13 illustrates an example wireless network, according to certain embodiments;

FIG. 14 illustrates an example network node, according to certain embodiments;

FIG. 15 illustrates an example wireless device, according to certain embodiments;

FIG. 16 illustrate an example user equipment, according to certain embodiments;

FIG. 17 illustrates a virtualization environment in which functions implemented by some embodiments may be virtualized, according to certain embodiments;

FIG. 18 illustrates a telecommunication network connected via an intermediate network to a host computer, according to certain embodiments;

FIG. 19 illustrates a generalized block diagram of a host computer communicating via a base station with a user equipment over a partially wireless connection, according to certain embodiments;

FIG. 20 illustrates a method implemented in a communication system, according to one embodiment;

FIG. 21 illustrates another method implemented in a communication system, according to one embodiment;

FIG. 22 illustrates another method implemented in a communication system, according to one embodiment;

FIG. 23 illustrates another method implemented in a communication system, according to one embodiment;

FIG. 24 illustrates a method by a network node operating as a first donor node for a wireless device, according to certain embodiments;

FIG. 25 illustrates an example virtual apparatus, according to certain embodiments;

FIG. 26 illustrates an example method by a network node operating as a second donor node for traffic offloading for a wireless device, according to certain embodiments;

FIG. 27 illustrates another example virtual apparatus, according to certain embodiments;

FIG. 28 illustrates another example method by a network node operating as a first donor node for a wireless device, according to certain embodiments;

FIG. 29 illustrates another example virtual apparatus, according to certain embodiments;

FIG. 30 illustrates an example method by a network node operating as a top-level node under a first donor node, according to certain embodiments;

FIG. 31 illustrates another example virtual apparatus, according to certain embodiments;

FIG. 32 illustrates another example method by a network node operating as a first donor node for a wireless device, according to certain embodiments; and

FIG. 33 illustrates an example method by a network node operating as a second donor node for a wireless device, according to certain embodiments.

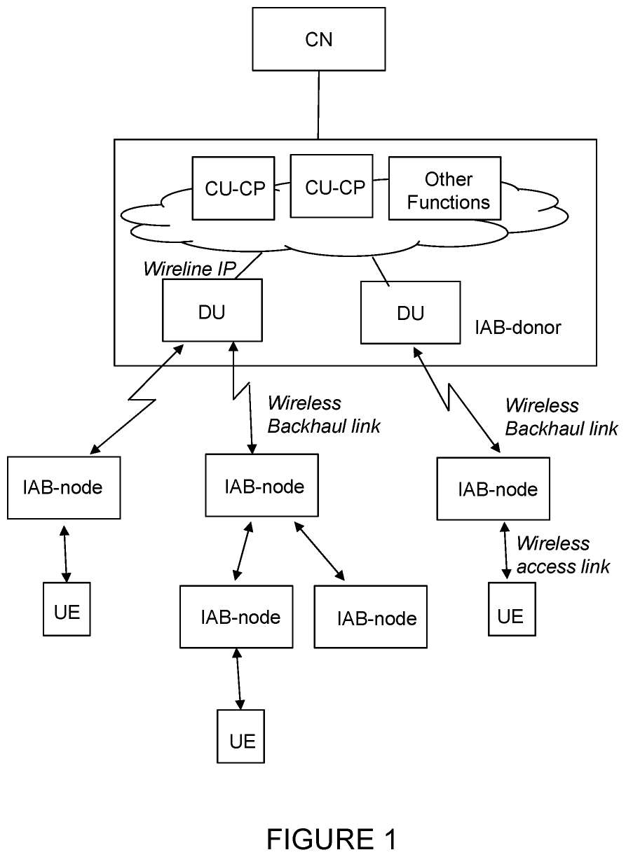

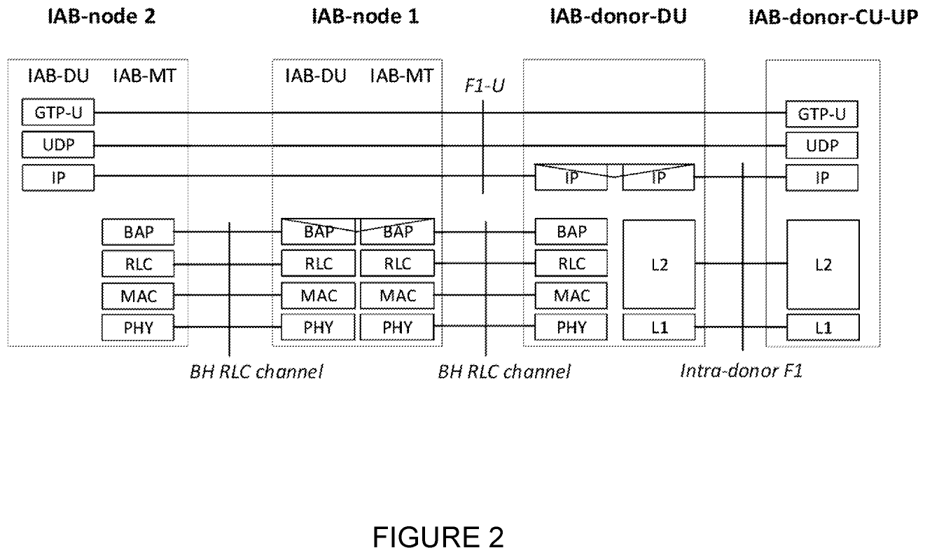

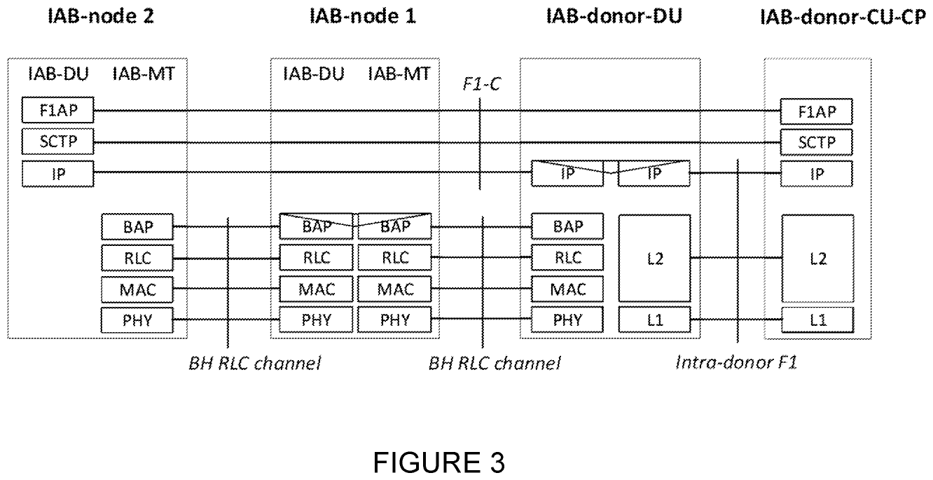

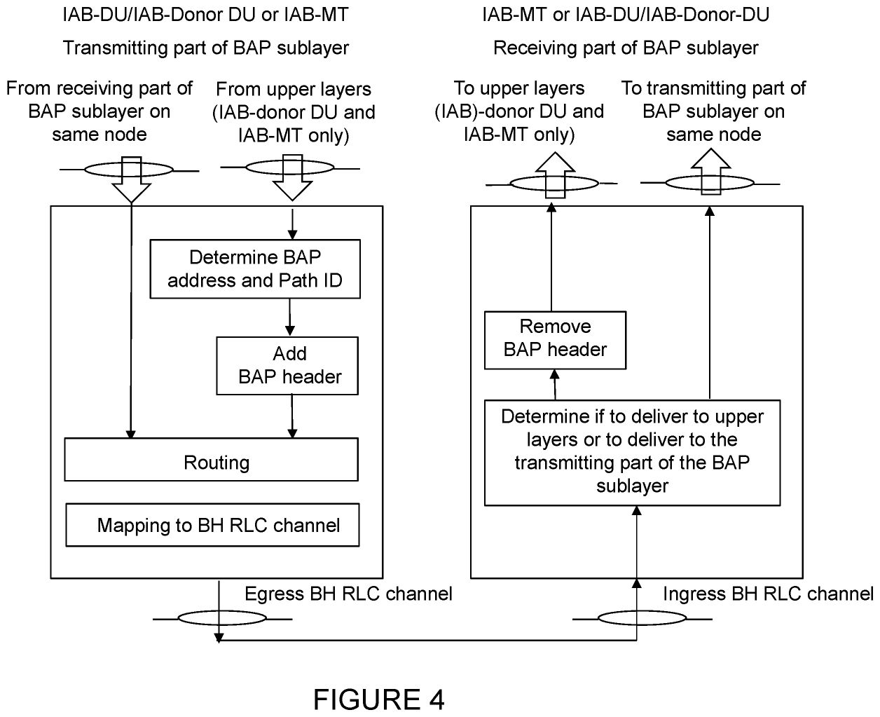

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate.

Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, Master eNB (MeNB), a network node belonging to Master Cell Group (MCG) or Secondary Cell Group (SCG), base station (BS), multi-standard radio (MSR) radio node such as MSR BS, eNodeB (eNB), gNodeB (gNB), network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations and Maintenance (O&M), Operations Support System (OSS), Self Organizing Network (SON), positioning node (e.g. Evolved-Serving Mobile Location Centre (E-SMLC)), Minimization of Drive Tests (MDT), test equipment (physical node or software), etc.

In some embodiments, the non-limiting term UE or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, Personal Digital Assistant (PDA), Tablet, mobile terminals, smart phone, laptop embedded equipped (LEE), laptop mounted equipment (LME), Unified Serial Bus (USB) dongles, UE category M1, UE category M2, Proximity Services UD (ProSe UE), Vehicle-to-Vehicle UE (V2V UE), Vehicle-to-Anything UE (V2X UE), etc.

Additionally, terminologies such as base station/gNB and UE should be considered non-limiting and do in particular not imply a certain hierarchical relation between the two; in general, “gNB” could be considered as device 1 and “UE” could be considered as device 2 and these two devices communicate with each other over some radio channel. And in the following the transmitter or receiver could be either gNB, or UE.

Although the title of this disclosure refers to IAB networks, some embodiments herein apply to UEs, regardless of whether they are served by an IAB network or a “non-IAB” Radio Access Network (RAN) node.

The terms “inter-donor traffic offloading” and “inter-donor migration” are used interchangeably.

The term “single-connected top-level node” refers to the top-level IAB-MT that can connect to only one donor at a time.

The term “dual-connected top-level node” refers to the top-level IAB-MT that can simultaneously connect to two donors.

The term “descendant node” may refer to both the child node and the child of the child and so on.

The terms “CU_1”, “source donor” and “old donor” are used interchangeably.

The terms “CU_2”, “target donor” and “new donor” are used interchangeably.

The terms “Donor DU_1”, “source donor DU” and “old donor DU” are used interchangeably.

The terms “Donor DU_2”, “target donor DU” and “new donor DU” are used interchangeably.

The term “parent” may refer to an IAB node or an IAB-donor DU.

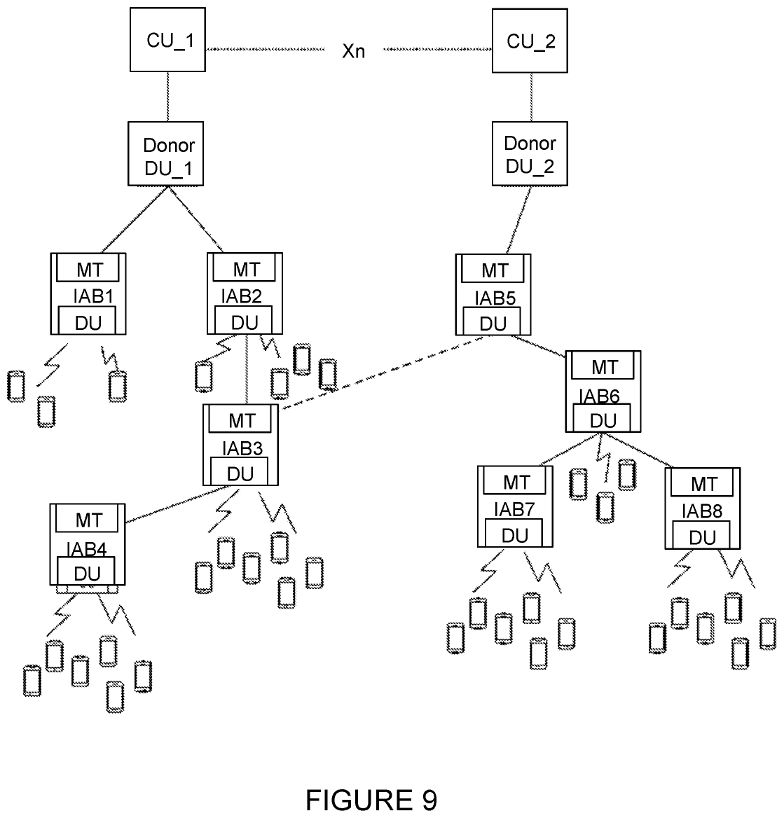

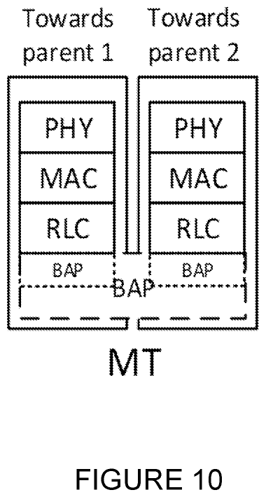

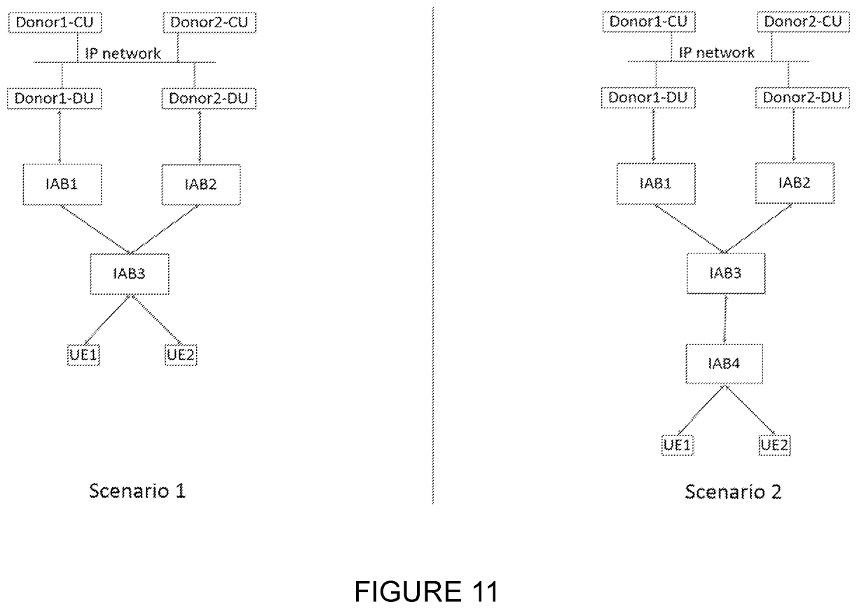

The terms “migrating IAB node” and “top-level IAB node” are used interchangeably:
In the proxy-based solution for inter-donor topology adaptation, they refer to the IAB-MT of this node (e.g. IAB3-MT in FIG. 9), because, in the collocated IAB-DU of the top-level node does not migrate (it maintains the F1 connection to the source donor).
In full migration-based solution, the entire node and its descendants migrate to another donor.

Some non-limiting examples of scenarios that this disclosure is based on are given below:
Inter-donor load balancing for a single-connected top-level node (e.g. IAB3-MT for FIG. 9) by using the proxy based solution (Section 2.1.1.5): here, the traffic carried to/from/via top-level IAB node is taken over by (i.e. proxied) a target donor (e.g. CU_2 in FIG. 9), i.e. the source donor (e.g. CU_1 in FIG. 9) offloads the traffic pertaining to the ingress/egress BH RLC channels between the said IAB node and its parent node to the target donor.
Inter-donor load balancing for a dual-connected top-level node (e.g. IAB3-MT for FIG. 9) by using the proxy based solution (described above): here, the traffic carried to/from/via top-level IAB node is taken over by (i.e. proxied) a target donor (load balancing), i.e. the source donor offloads the traffic pertaining to the ingress/egress BH RLC channels between the said IAB node and its parent node to the top-level node's leg towards the target donor.
Inter-donor RLF recovery of a single-connected top-level node, caused by RLF on a link to the said IAB node's parent, or on a link between the said IAB node's parent and parent's parent, where the said node (i.e. top-level node) performs reestablishment at a parent under target donor.
Inter-donor RLF recovery of a dual-connected top-level node, caused by RLF on a link to the said IAB node's parent, or on a link between the said IAB node's parent and parent's parent, where the traffic of the said node (i.e. top-level node) is completely moved to the leg of the said node towards the target donor.
IAB node handover to another donor.
Local inter-donor rerouting (UL and/or DL), where the newly selected path towards the donor or the destination IAB node leads via another donor.
Any of the example scenarios above, where full migration-based solution (as described above) is applied (instead of the proxy-based solution).

Top-level IAB node consists of top-level IAB-MT and its collocated IAB-DU (sometimes referred to as the “collocated DU” or the “top-level DU”). Certain aspects of this disclosure refer to the proxy-based solution for inter-donor topology adaptation, and certain refer to the full migration-based solution, described above.

The terms “RRC/F1 connections of descendant devices” refers to the RRC connections of descendant IAB-MTs and UEs with the donor (source donor in this case), and the F1 connections of the top-level IAB-DU and IAB-DUs of descendant IAB nodes of the top-level IAB node.

Traffic between the CU_1 and the top-level IAB node and/or its descendant nodes (also referred to as the proxied traffic) refers to the traffic between the CU_1 and:
1. the collocated IAB-DU part of the top-level IAB node (since the IAB-MT part of the top-level IAB node has migrated its RRC connection to the new donor),
2. the descendant IAB nodes of the top-level IAB node, and
3. the UEs served by the top-level node and its descendant nodes.

According to certain embodiments, the assumption is that, for traffic offloading, direct routing between CU_1 and Donor DU_2 is applied (i.e. CU_1-Donor DU_1- and so on . . . ), rather than the indirect routing case, where the traffic goes first to CU_2, i.e. CU_1-CU_2-Donor DU_1- and so on . . . . The direct routing can, for example, be supported via IP routing between (source donor) CU_1 and donor DU2 (target donor DU) or via an Xn connection between the two. In indirect routing, data can be sent between CU_1 and CU_2 via Xn interface, and between CU_2 and Donor DU_2 via F1 or via IP routing. Both direct and indirect routing are applicable in this disclosure. The advantage of direct routing is that the latency is likely smaller.

Herein, it is assumed that, both user plane and control plane traffic are sent from/to the source donor via target donor to/from the top-level node and its descendants by means of direct and indirect routing.

The term “destination is IAB-DU”, comprises both the traffic whose final destination is either the said IAB-DU or a UE or IAB-MT served by the said IAB-DU, and that includes top-level IAB-DU as well.

The term “data” refers to both user plane, control plane traffic and non-F1 traffic.

The considerations in this disclosure are equally applicable for both static and mobile IAB nodes.

As used herein, the term “offloaded traffic” includes UL and/or DL traffic.

As used herein, a revocation of traffic offloading means a revocation of all traffic previously offloaded from CU1 to CU2 and/or from CU2 to CU1.

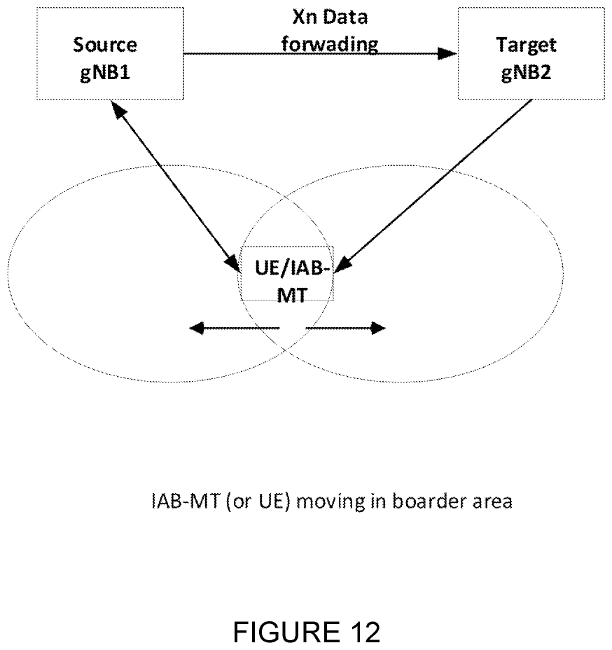

FIG. 12 illustrates an example DAPS/DIPS revocation scenario. UE currently served by the source gNB1 has DAPS set up towards target gNB2. However, the UE instead of moving towards target gNB2 moves towards source gNB1. In such case, a revocation of the DAPS configured towards gNB2 needs to be sent. UE can send measurement report where cell from source gNB1 gets better by certain margin as compared to cell from target gNB; hence source CU may decide to revoke the DAPS. The above scenario is also applicable for an IAB-MT, in case DAPS (or DIPS) is configured for the IAB-MT (herein, the IAB-MT is not necessarily mobile, so the DAPS/DIPS revocation may be desired for other reasons, as well).

On the other hand, in addition to using DAPS during UE handover, it could also make sense to use DAPS for load balancing between two RAN nodes (although this is not specified). In that case, having in mind the temporary nature of load balancing scenarios, it is unclear how DAPS for a UE could be revoked, in case UE DAPS is used for load balancing.

According to certain embodiments, methods and systems are provided for any combination of:
Revoking (i.e. deconfiguring) traffic offloading to another donor in case of inter-donor load balancing or inter-donor RLF recovery.
Revoking (i.e. deconfiguring) the inter-donor topological redundancy or the offloading by using already existing inter-donor topological redundancy in an IAB network, where an IAB node is simultaneously connected to two donors by e.g. using the Dual IAB Protocol Stack (DIPS).
Revoking (i.e. deconfiguring) DAPS configured at a UE for the purpose of load balancing between two RAN nodes.

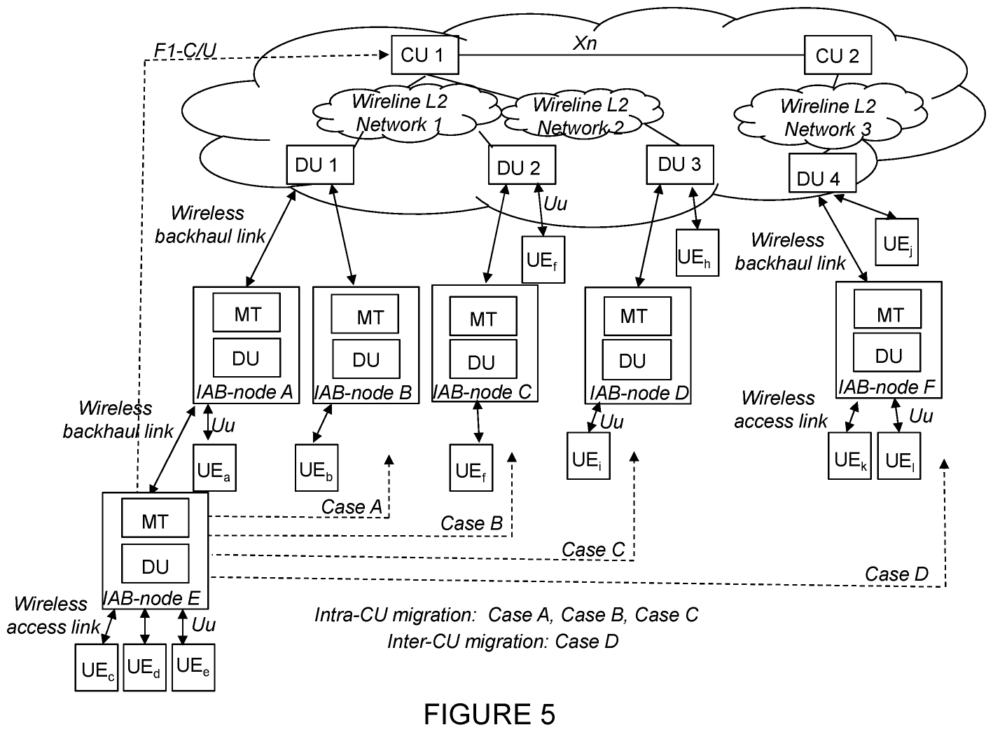

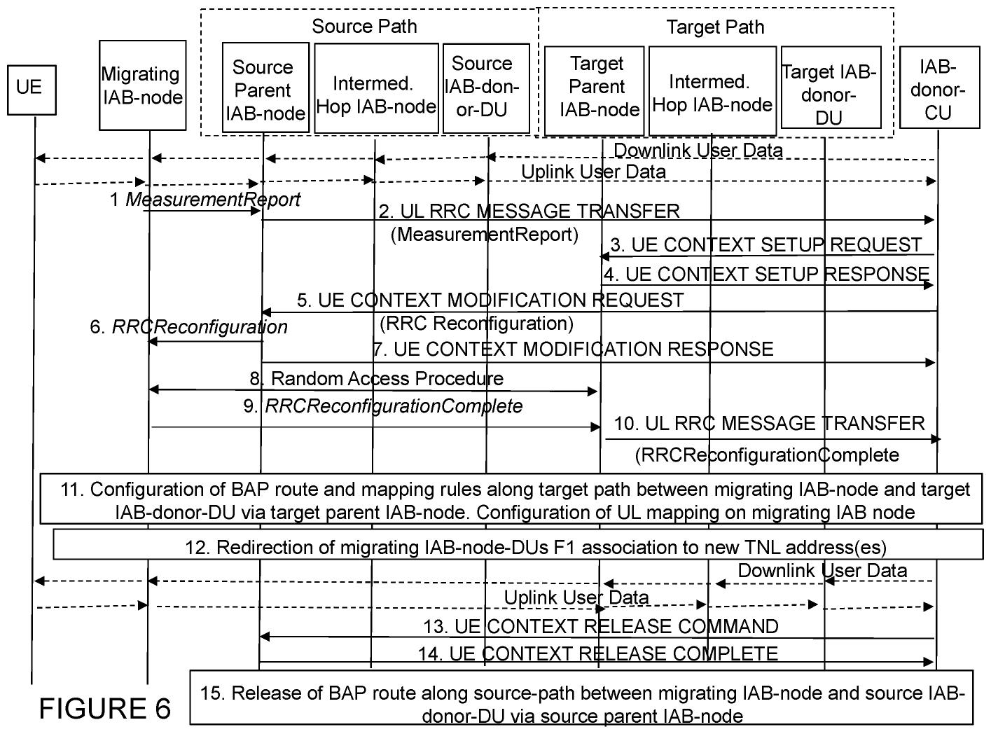

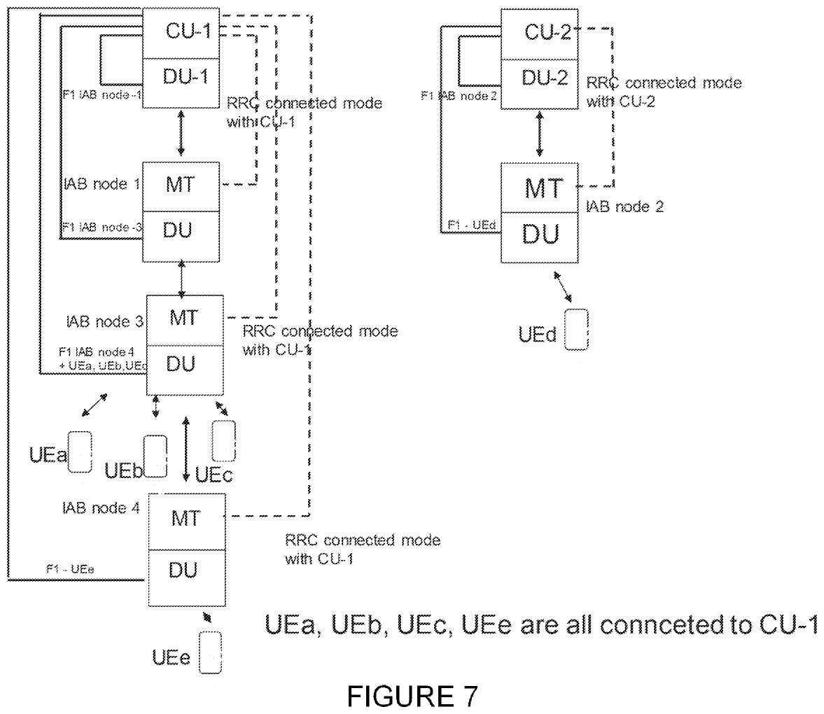

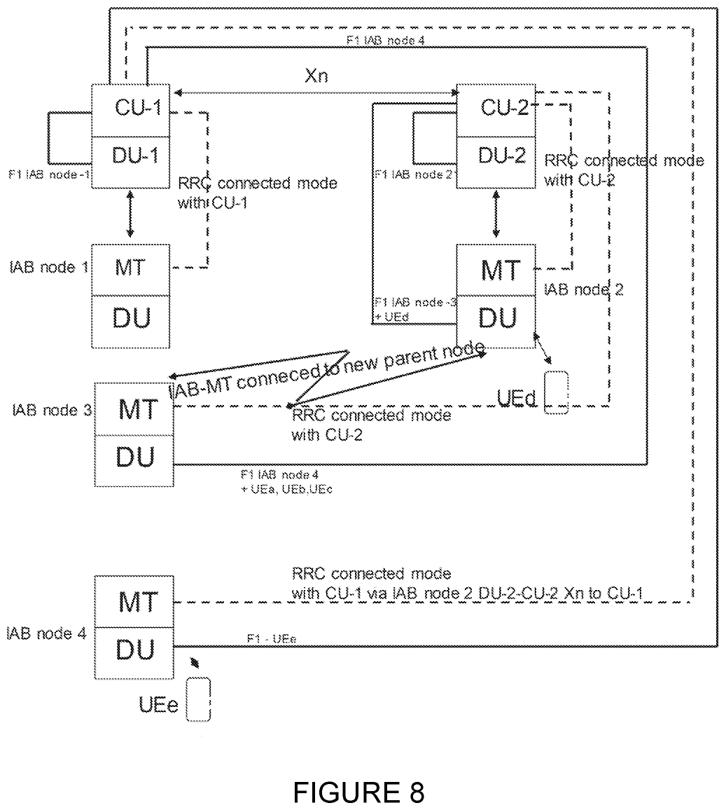

In other words, if FIG. 5 is used as an example, these methods aim at returning from Case A-D back to a configuration similar to the initial configuration, which may include a configuration in which the IAB is connected to the initial CU (e.g. IAB-Node A/CU_1). From a terminology point of view, revocation can be implemented as a reconfiguration procedure.

### Revocation of Inter-Donor Traffic Offloading

Herein, the terms “old donor” and “CU_1” refer to the donor that has previously offloaded traffic to the “new donor”/“CU_2”. In case of inter-donor RLF recovery, the top-level node, upon experiencing and RLF towards its parent under CU_1 connects to a new parent under CU_2.

According to certain embodiments, it may be assumed that the proxy-based solution is used for traffic offloading. The steps proposed according to certain embodiments are as follows:
Step 1: CU_1 determines that the causes for offloading traffic via CU_2 are no longer valid. For example, CU_1 determines that the traffic load in its network has dropped.
Step 2: CU_1 indicates to the top-level node (e.g. to the IAB-DU of the top-level node via F1 interface) that offloading is revoked. This can be done updating the re-routing rules or sending an indication that no more UL user plane traffic is sent via CU_2. This prevents that traffic is discarded or lost.
   After receiving such indication, the IAB-MT will add a flag in the last UL user plane packet which is transmitted towards Donor DU_2 to indicating that the packet carrying the flag is the last packet. Alternatively, this flag can be indicated in a BAP PDU which should reach Donor DU_2.
Step 3: CU_1 sends to CU_2 a message requesting a revocation of traffic offloading from CU_1 to CU_2.
   The revocation may apply to all example scenarios listed above.
   The revocation message towards CU_2 may also contain an indication that suggests to which parent node under CU_1 the top-level IAB-MT should connect. Herein, it is assumed that this parent under CU_1 is the old parent of top-level node, i.e. its parent before offloading.
Step 4′: Upon receiving the revocation message, CU_2 sends a response to CU_1, confirming the revocation, and instructs the top-level IAB-MT to connect to a parent under CU_1. The revocation includes the migration of the top-level IAB-MT's RRC connection from CU_2 back to CU_1, which results in the path of the traffic terminated at or traversing top-level node being (again) entirely in the CU_1 network.
   The migration back to CU_1 may be executed by IAB-MT undergoing a handover back to CU_1, where the configurations described in Step 5 can be activated at the top-level node, after it connects to a parent under CU_1.
Step 4″: Alternatively, upon receiving the revocation message, the CU_2 could command to Donor DU_2 to add a flag to the last DL user plane packet using one of the methods listed above i.e. adding it in the user plane packet or using a BAP PDU. When this reaches the top-level IAB, the top-level IAB have few options:
   It may send an ACK for that message so that the Donor DU_2 is aware there are no more outstanding DL user plane packets.
In case the top-level node sent the indication to flag the last UL user plane packet, CU_1 transmits the response once there are no more UL outstanding user plane packets. If a similar solution is done for the DL, then the CU_1 waits until it is confirmed that there are no more outstanding user plane packets in the DL. Or, it may wait until it confirms that there are no more outstanding user plane packets in either direction.
Alternatively, the CU_1 may apply a timer started after the revocation message has received, or after the CU_2 commands Donor DU_2 to add a flag to indicate no more DL transmissions on flight. When the timer expires, the CU_2 would send a response to CU_1 unless other event has triggered before the transmission of the response to CU_1.
Step 5: CU_1 configures the old ancestors of the top-level node (i.e. its ancestors under CU_1) to enable them to serve the traffic towards top-level node, once the node re-connects to its old parent under CU_1. These configurations are, for example, routing configurations at the old ancestors of the top-level node.
   Upon returning the traffic to the CU_1 network, the BAP routing IDs, BAP addresses, IP addresses and BH RLC channel IDs of all affected nodes that were used before topology adaptation, may or may not be used again by these nodes.
Step 6: In case the revocation is possible, CU_1 indicates to the top-level node (e.g. to the IAB-DU of the top-level node via F1 interface) that a new set of configurations should be applied.
   In case the configurations (e.g. ingress-egress mapping, routing configurations etc.) of the top-level node that were used before offloading (i.e. before the top-level IAB-MT connected to a parent under CU_2) were suspended, rather than released/deleted at the top-level node, the revocation message contains an indication to the node to re-activate these configurations.
   In case the old configurations of top-level node were deleted prior to offloading, the revocation message contains the configurations to be used by the top-level node, upon return to the parent under CU_1 (these can be for example, routing configurations at the top-level node, for the traffic towards its descendant nodes and UEs).
   Alternatively, Step 6 can be executed by CU_2, where CU_2 communicates to top-level node via RRC.
Step 7: top-level node connects to a parent under the old donor and the traffic to/from/via top-level node that was previously offloaded to CU_2 now continues to flow via the old path.
   In one variation, it is possible that the actual path after revoking is different from the path before offloading. In another variation, the BAP routing IDs, BAP addresses, IP addresses and BH RLC channel IDs of all affected nodes after offloading revocation are the same as the ones used before offloading, but the actual traffic path(s) from CU_1 to top-level node are different.
   The parent of the top-level node under the CU_1 after revocation can be the same as the parent before offloading to CU_1, or it can be another parent under CU_1. The said parent can be suggested by CU_2 or CU_1, e.g. based on traffic load or measurement reports from top-level IAB-MT.
It may be noted that the above solutions and embodiments are also applicable in case of topological redundancy i.e. a dual-connected top-level node. As discussed in the background section, the fact that top-level node is able to simultaneously connect to two donors (by means of Dual Connectivity (DC) or DIPS, still under discussion) can be used to offload the traffic to/from/via top-level node from a congested leg towards a donor to an uncongested leg towards another donor. This effectively means that there would be no need for migrating neither the top-level node nor its descendants between donors i.e. the proxy-based solution described above would be applied. The fact that top-level node is able to simultaneously connect to two donors means that it is possible to offload one part of traffic to/from/via top-level node, rather than the entire traffic, which was the case for a single-connected top-level node.

### CU_2-Triggered Revocation of Inter-Donor Traffic Offloading

According to certain other embodiments, revocation can also be initiated by CU_2, where the revocation applies to the previously offloaded traffic from CU_1 to CU_2. The causes for revocation can be e.g.:
CU_2 determines that it can no longer serve the offloaded traffic, or
CU_2 determines, via measurement reports received by the top-level IAB-MT, that signal quality between the top-level IAB-MT and its old parent under CU_1 is sufficiently good and that the corresponding link can again be established, or
CU_2 may have committed for offloading only till certain duration and the duration is over
   So, in this case:
CU_2 determines that offloading should be revoked, due to e.g. the reasons listed above.
CU_2 executes the actions described above for CU_1 (i.e. the roles of CU_1 and CU_2 from Step 2, as described above with regard to CU1-triggered revocation, are switched).
   Step 2 is still performed by CU_1.
   Step 4″ is still performed by CU_2.
CU_1 sends the revocation response to CU_2 and CU_1 executes Steps 5 and 6, as described above with regard to CU1-triggered revocation.
   Alternatively, Step 6 can be executed by CU_2, where CU_2 communicates to top-level node via RRC.
Step 7, as described above with regard to CU1-triggered revocation, is executed.

### Revocation in Case of Full Inter-Donor Migration

In this case, the steps can be as follows:
Step 1: Either Donor CU_1 or Donor CU_2 determines the need to revoke the offloading, as described above.
Step 2′: If Donor CU_1 triggers the revocation, CU_1 indicates which nodes are to be migrated back to CU_1, indication being by means of e.g. BAP address or any other identifier.
   Donor CU_2 sends the revocation response and it initiates the full migration-based inter-donor migration, as described in the Background Section.
Step 2″: If Donor CU_2 triggers the revocation, it simply initiates the full migration-based inter-donor migration, as described in the Background Section.
   In one variant, the full-migration based procedure where nodes are returned from CU_2 to CU_1 may carry an indication to CU_1 that the nodes for which the migration is sought have previously been subject to migration from CU_1 to CU_2.
      Revocation of DAPS that is Used for Load Balancing a UE's Traffic

DAPS is originally designed for UEs, to reduce service interruption at handover. However, it seems meaningful (although it is not specified) to use the DAPS for load balancing of UE traffic. In this case, when being served by a RAN node (herein referred to as the source RAN node) a UE could establish DAPS towards another RAN node (herein referred to as the target RAN node), whereas the UE's traffic would be delivered partially via the source and partially via the target RAN node.

According to certain embodiments, the revocation of DAPS for load balancing could be accomplished as follows:
The source RAN node (i.e. the RAN node serving the UE prior to activation of DAPS towards the source and target RAN nodes) determines that the need for load balancing has ceased.
The source RAN node sends a revocation message to the target RAN node.
The target RAN node confirms the revocation of DAPS.
The target RAN node or source RAN node indicates to the UE that the DAPS is revoked.
The source RAN node executes the necessary configurations (e.g. the DU that is controlled by the source RAN node and that serves the UE) in order to take back the offloaded traffic pertaining to the UE, and the target RAN node also executes the necessary measures in its own network, i.e. frees up the resources that were consumed by the offloaded traffic.

Alternatively, target RAN node can also determine the need to revoke DAPS, in which case it sends the revocation request to the source RAN node, and the source RAN node replies with revocation response. In this case also, either the source or target RAN node can indicate to the UE that DAPS is deconfigured.

In case the UE is served by the IAB network, the necessary reconfigurations of the nodes under the CU_1 (i.e. source node) and CU_2 (i.e. the target node) can be done by CU_1 and CU_2, respectively, in a similar way to what is described above.

In the above, a RAN node, can be any of the following: gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB.

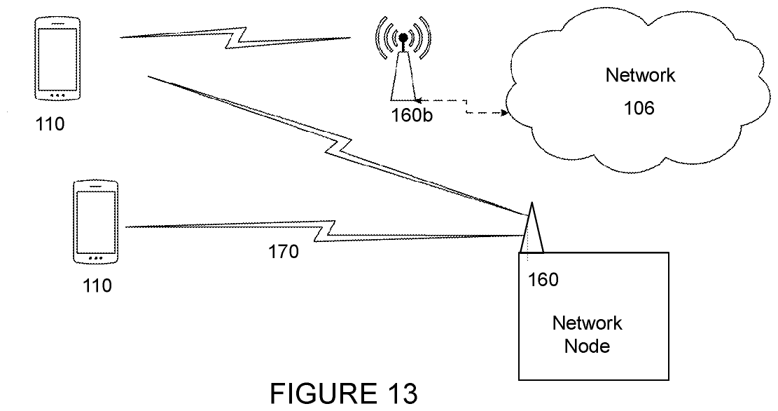

FIG. 13 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 13. For simplicity, the wireless network of FIG. 13 only depicts network 106, network nodes 160 and 160b, and wireless devices 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

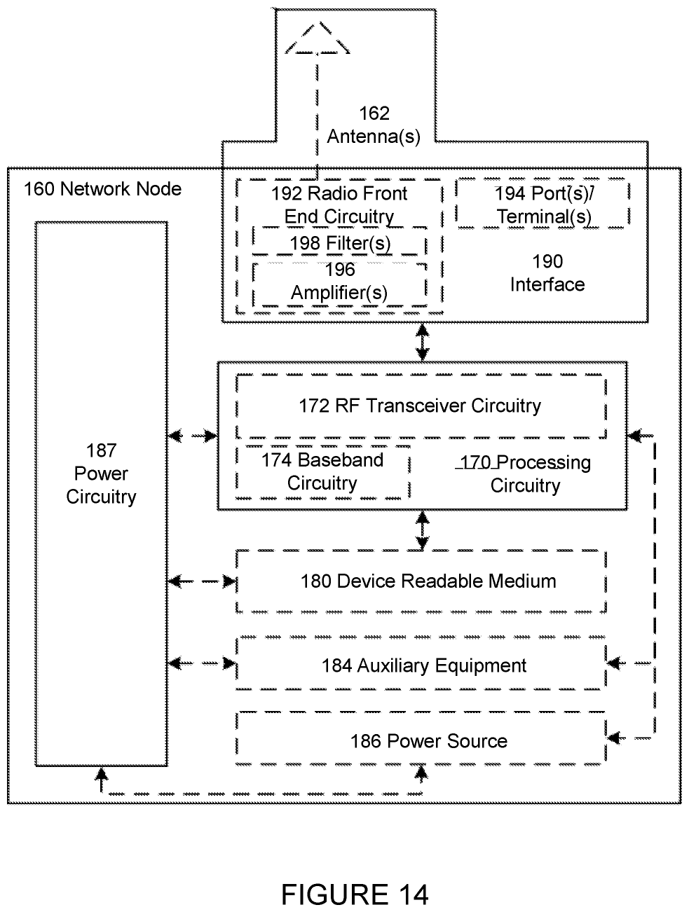

FIG. 14 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 14, network node 160 includes processing circuitry 170, device readable medium 180, interface 190, auxiliary equipment 184, power source 186, power circuitry 187, and antenna 162. Although network node 160 illustrated in the example wireless network of FIG. 14 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 14 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

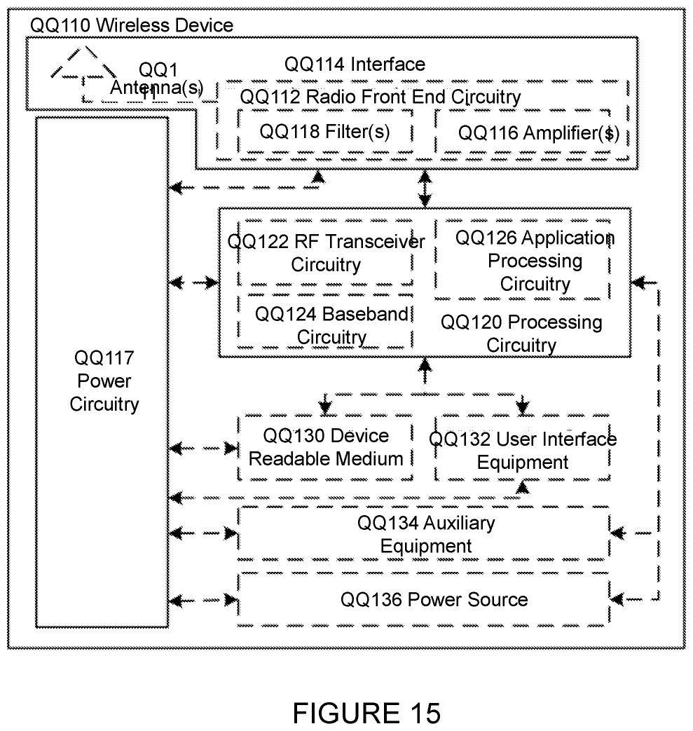

FIG. 15 illustrates an example wireless device 110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

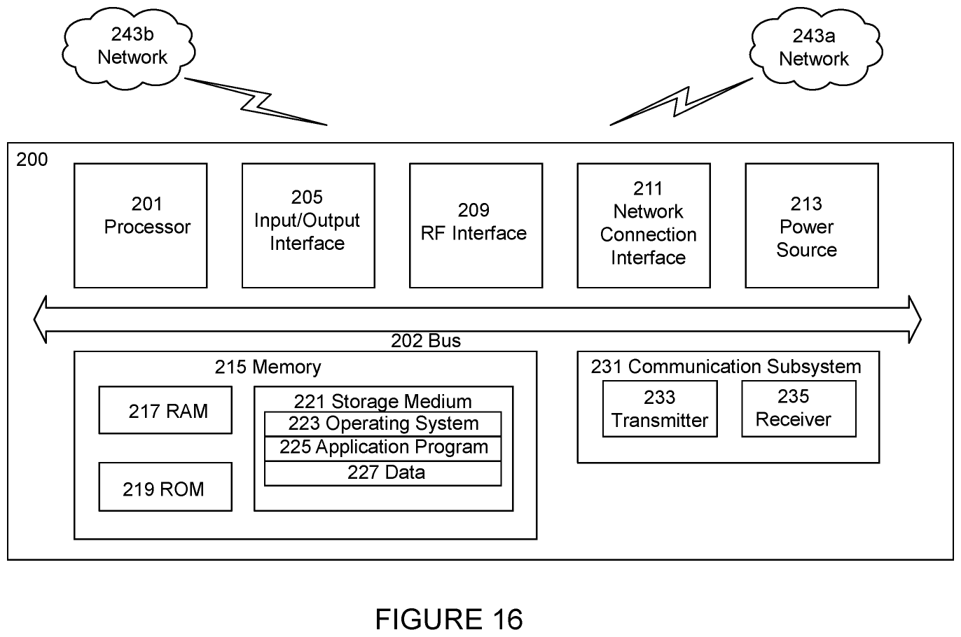

FIG. 16 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 14, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 16 is a UE, the components discussed herein are equally applicable to a wireless device, and vice-versa.

In FIG. 16, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 16, or only a subset of the components. The level of integration between the components may vary from one UE to another UE. Further, certain UEs may contain multiple instances of a component, such as multiple processors, memories, transceivers, transmitters, receivers, etc.

In FIG. 16, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 16, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 16, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

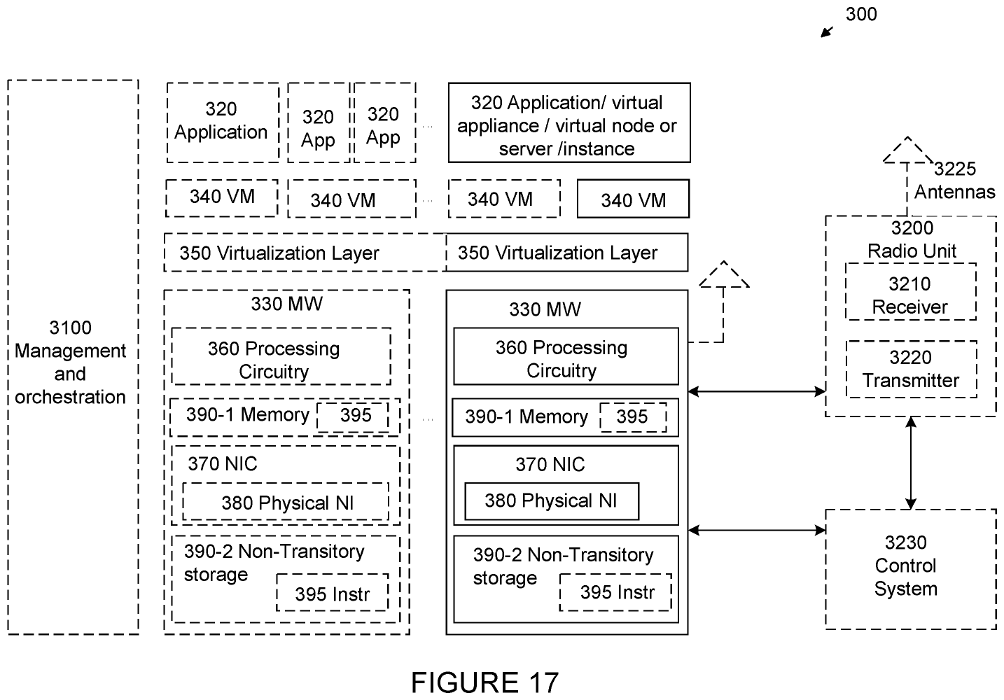

FIG. 17 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 17, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 17.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

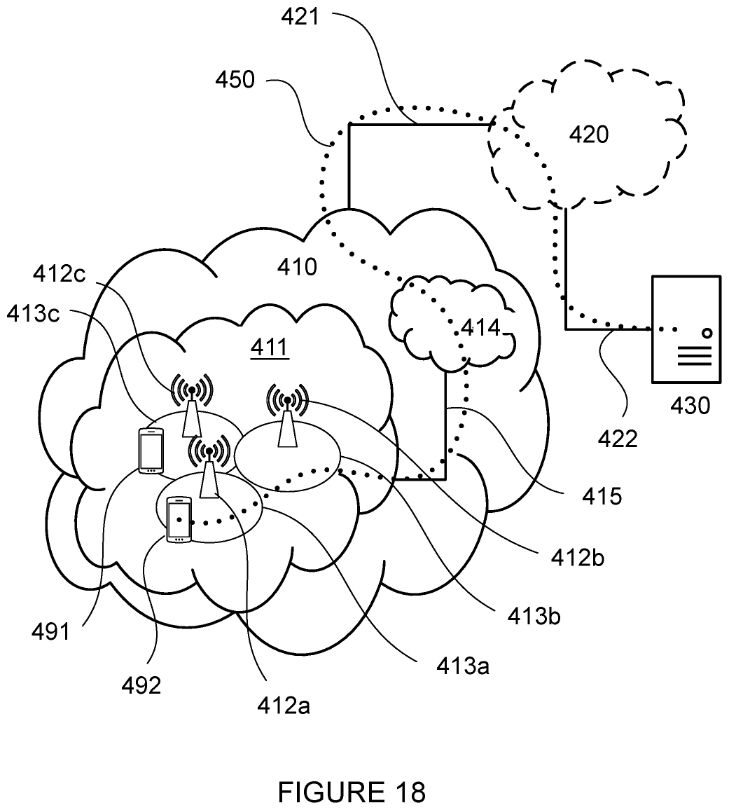

FIG. 18 illustrates a telecommunication network connected via an intermediate network to a host computer in accordance with some embodiments.

With reference to FIG. 18, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 18 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

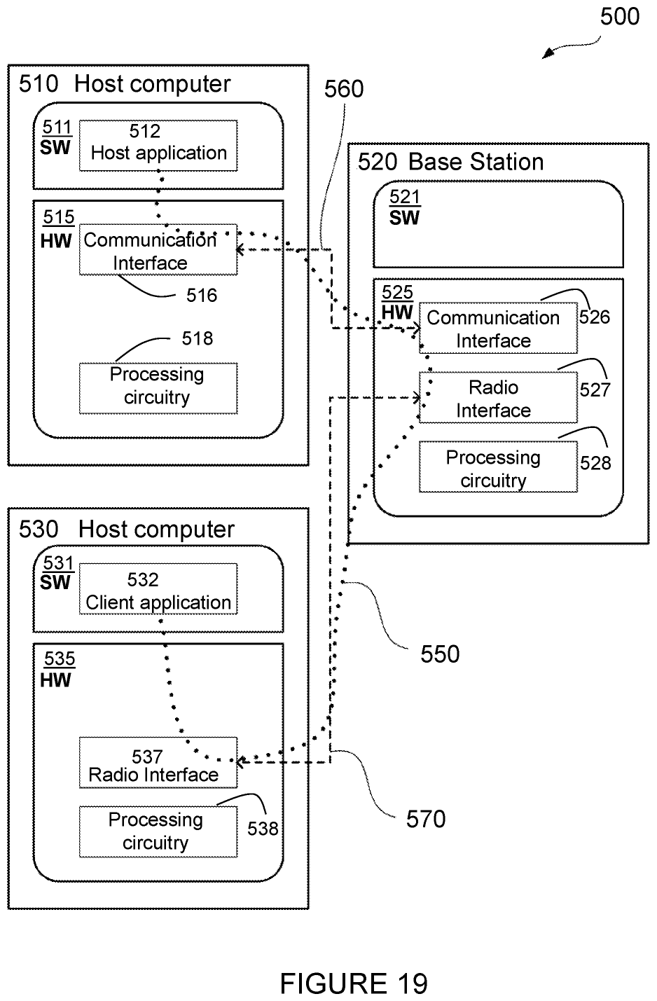

FIG. 19 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 19. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 19) served by base station 520. Communication interface 526 may be configured to facilitate connection 560 to host computer 510. Connection 560 may be direct or it may pass through a core network (not shown in FIG. 19) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 19 may be similar or identical to host computer 430, one of base stations 412a, 412b, 412c and one of UEs 491, 492 of FIG. 18, respectively. This is to say, the inner workings of these entities may be as shown in FIG. 19 and independently, the surrounding network topology may be that of FIG. 18.

In FIG. 19, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

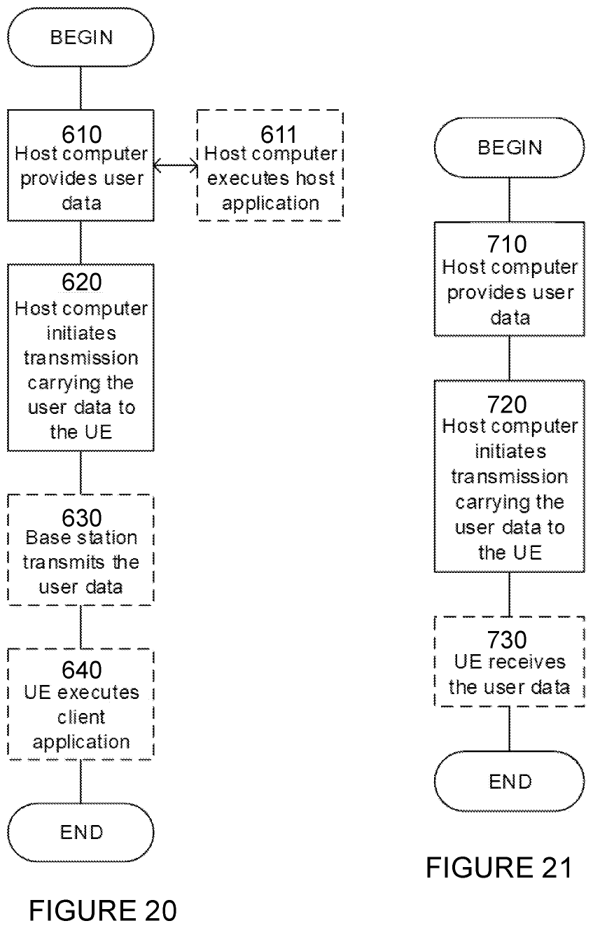

FIG. 20 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 20 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 21 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 21 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

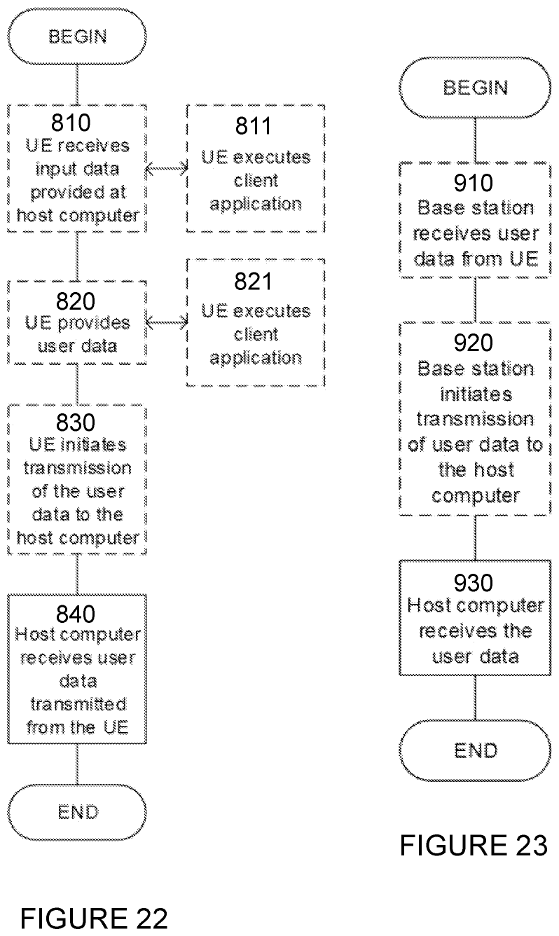

FIG. 22 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 22 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 23 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 23 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

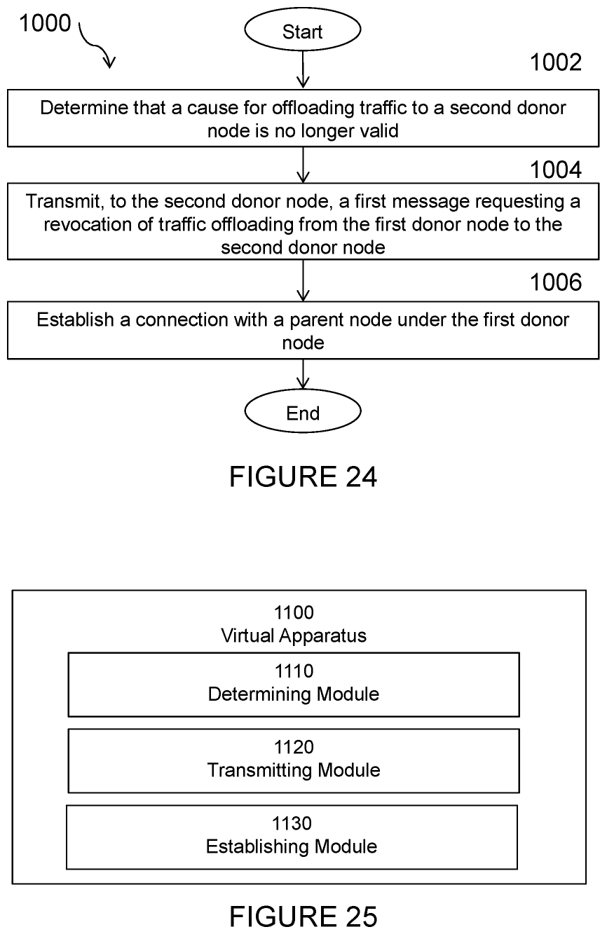

FIG. 24 depicts a method 1000 by a network node 160 operating as a first donor node for a wireless device 110, according to certain embodiments. At step 1002, the network node 160 determines that a cause for offloading traffic to a second donor node is no longer valid. At step 1004, the network node 160 transmits, to the second donor node, a first message requesting a revocation of traffic offloading from the first donor node to the second donor node. At step 1006, the network node 160 establishes a connection with a parent node under the first donor node.

In various particular embodiments, the method may additionally or alternatively include one or more of the steps or features of the Group A, B, C, D, and E Example Embodiments described below.

FIG. 25 illustrates a schematic block diagram of a virtual apparatus 1100 in a wireless network (for example, the wireless network shown in FIG. 13). The apparatus may be implemented in a network node (e.g., network node 160 shown in FIG. 13). Apparatus 1100 is operable to carry out the example method described with reference to FIG. 24 and possibly any other processes or methods disclosed herein. It is also to be understood that the method of FIG. 24 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining module 1110, transmitting module 1120, establishing module 1130, and any other suitable units of apparatus 1100 to perform corresponding functions according one or more embodiments of the present disclosure.

According to certain embodiments, determining module 1110 may perform certain of the determining functions of the apparatus 1100. For example, determining module 1110 may determine that a cause for offloading traffic to a second donor node is no longer valid.

According to certain embodiments, transmitting module 1120 may perform certain of the transmitting functions of the apparatus 1100. For example, transmitting module 1120 may transmit, to the second donor node, a first message requesting a revocation of traffic offloading from the first donor node to the second donor node.

According to certain embodiments, establishing module 1130 may perform certain of the establishing functions of the apparatus 1100. For example, establishing module 1120 may establish a connection with a parent node under the first donor node.

Optionally, in particular embodiments, virtual apparatus may additionally include one or more modules for performing any of the steps or providing any of the features in the Group A and Group C Example Embodiments described below.

As used herein, the term module or unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

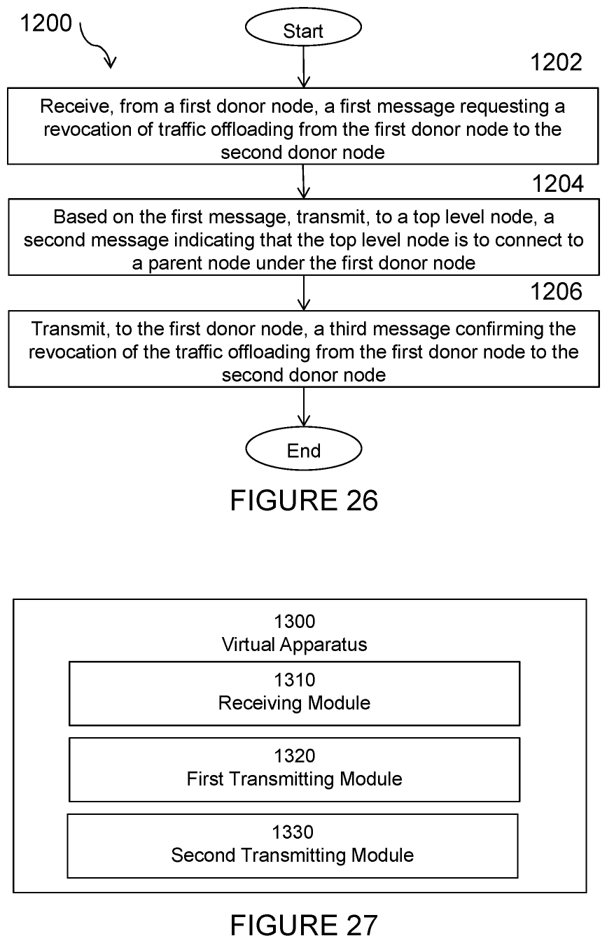

FIG. 26 depicts a method 1200 by a network node 160 operating as a second donor node for traffic offloading for a wireless device, according to certain embodiments. At step 1202, the network node 160 receives, from a first donor node, a first message requesting a revocation of traffic offloading from the first donor node to the second donor node. Based on the first message, the network node 160 transmits, to a top level node, a second message indicating that the top level node is to connect to a parent node under the first donor node, at step 1204. At step 1206, the network node 160 transmits, to the first donor node, a third message confirming the revocation of the traffic offloading from the first donor node to the second donor node.

In various particular embodiments, the method may include one or more of any of the steps or features of the Group A, B, C, D, and E Example Embodiments described below.

FIG. 27 illustrates a schematic block diagram of a virtual apparatus 1300 in a wireless network (for example, the wireless network shown in FIG. 13). The apparatus may be implemented in a wireless device or network node (e.g., network node 160 shown in FIG. 13). Apparatus 1300 is operable to carry out the example method described with reference to FIG. 26 and possibly any other processes or methods disclosed herein. It is also to be understood that the method of FIG. 26 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1310, first transmitting module 1320, second transmitting module 1330, and any other suitable units of apparatus 1300 to perform corresponding functions according one or more embodiments of the present disclosure.

According to certain embodiments, receiving module 1310 may perform certain of the receiving functions of the apparatus 1300. For example, receiving module 1310 may receive, from a first donor node, a first message requesting a revocation of traffic offloading from the first donor node to the second donor node.

According to certain embodiments, first transmitting module 1320 may perform certain of the transmitting functions of the apparatus 1300. For example, first transmitting module 1320 may transmit, to a top level node, a second message indicating that the top level node is to connect to a parent node under the first donor node based on the first message.

According to certain embodiments, second transmitting module 1330 may perform certain of the transmitting functions of the apparatus 1300. For example, second transmitting module 1320 may transmit, to the first donor node, a third message confirming the revocation of the traffic offloading from the first donor node to the second donor node.

Optionally, in particular embodiments, virtual apparatus may additionally include one or more modules for performing any of the steps or providing any of the features in the Group A, B, C, D, and E Example Embodiments described below.

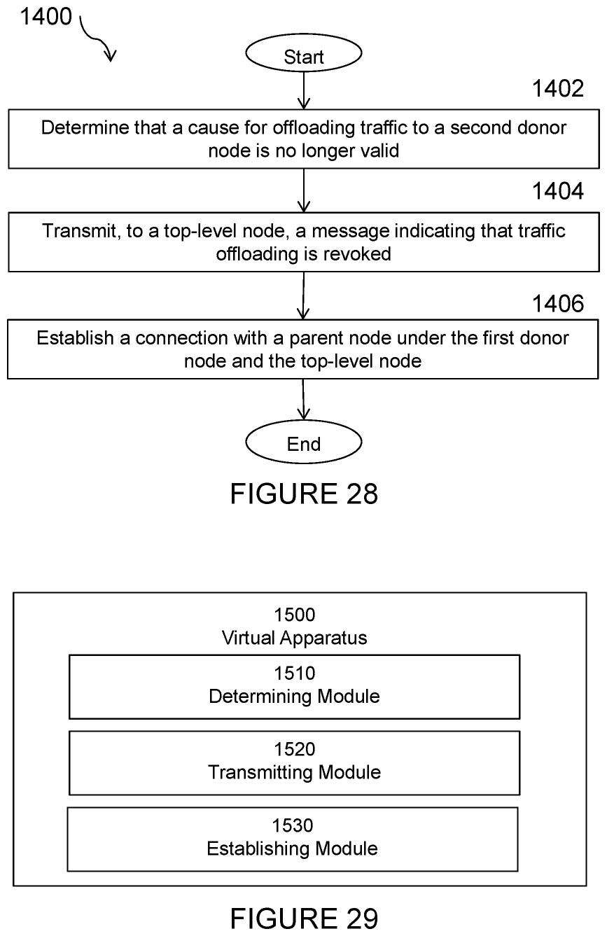

FIG. 28 depicts a method 1400 by a network node 160 operating as a first donor node for a wireless device 110, according to certain embodiments. At step 1402, the network node 160 determines that a cause for offloading traffic to a second donor node is no longer valid. At step 1404, the network node 160 transmits, to a top-level node, a message indicating that traffic offloading is revoked. At step 1406, the network node 160 establishes a connection with a parent node under the first donor node and the top-level node.

In various particular embodiments, the method may include one or more of any of the steps or features of the Group A, B, C, D, and E Example Embodiments described below.

FIG. 29 illustrates a schematic block diagram of a virtual apparatus 1500 in a wireless network (for example, the wireless network shown in FIG. 13). The apparatus may be implemented in a wireless device or network node (e.g., wireless device 110 or network node 160 shown in FIG. 13). Apparatus 1500 is operable to carry out the example method described with reference to FIG. 28 and possibly any other processes or methods disclosed herein. It is also to be understood that the method of FIG. 28 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining module 1510, transmitting module 1520, establishing module 1530, and any other suitable units of apparatus 1500 to perform corresponding functions according one or more embodiments of the present disclosure.

According to certain embodiments, determining module 1510 may perform certain of the determining functions of the apparatus 1500. For example, determining module 1510 may determine that a cause for offloading traffic to a second donor node is no longer valid.

According to certain embodiments, transmitting module 1520 may perform certain of the transmitting functions of the apparatus 1500. For example, transmitting module 1520 may transmit, to a top-level node, a message indicating that traffic offloading is revoked.

According to certain embodiments, establishing module 1530 may perform certain of the establishing functions of the apparatus 1500. For example, establishing module 1530 may establish a connection with a parent node under the first donor node and the top-level node.

Optionally, in particular embodiments, virtual apparatus may additionally include one or more modules for performing any of the steps or providing any of the features in the Group A, B, C, D, and E Example Embodiments described below.

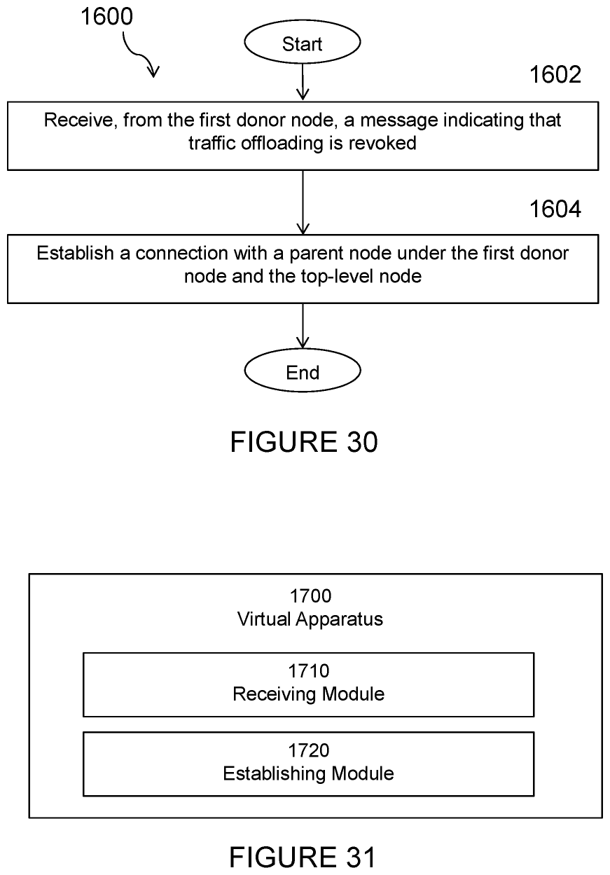

FIG. 30 depicts a method 1600 by a network node 160 operating as a top-level node under a first donor node, according to certain embodiments. At step 1602, the network node 160 receives, from the first donor node, a message indicating that traffic offloading is revoked. At step 1604, the network node 160 establishes a connection with a parent node under the first donor node and the top-level node.

In various particular embodiments, the method may include one or more of any of the steps or features of the Group A, B, C, D, and E Example Embodiments described below.

FIG. 31 illustrates a schematic block diagram of a virtual apparatus 1700 in a wireless network (for example, the wireless network shown in FIG. 13). The apparatus may be implemented in a wireless device or network node (e.g., network node 160 shown in FIG. 13). Apparatus 1700 is operable to carry out the example method described with reference to FIG. 30 and possibly any other processes or methods disclosed herein. It is also to be understood that the method of FIG. 30 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1710, establishing module 1720, and any other suitable units of apparatus 1700 to perform corresponding functions according one or more embodiments of the present disclosure.

According to certain embodiments, receiving module 1710 may perform certain of the receiving functions of the apparatus 1700. For example, receiving module 1710 may receive, from the first donor node, a message indicating that traffic offloading is revoked.

According to certain embodiments, establishing module 1720 may perform certain of the establishing functions of the apparatus 1700. For example, establishing module 1720 may establish a connection with a parent node under the first donor node and the top-level node.

Optionally, in particular embodiments, virtual apparatus may additionally include one or more modules for performing any of the steps or providing any of the features in the Group A, B, C, D, and E Example Embodiments described below.

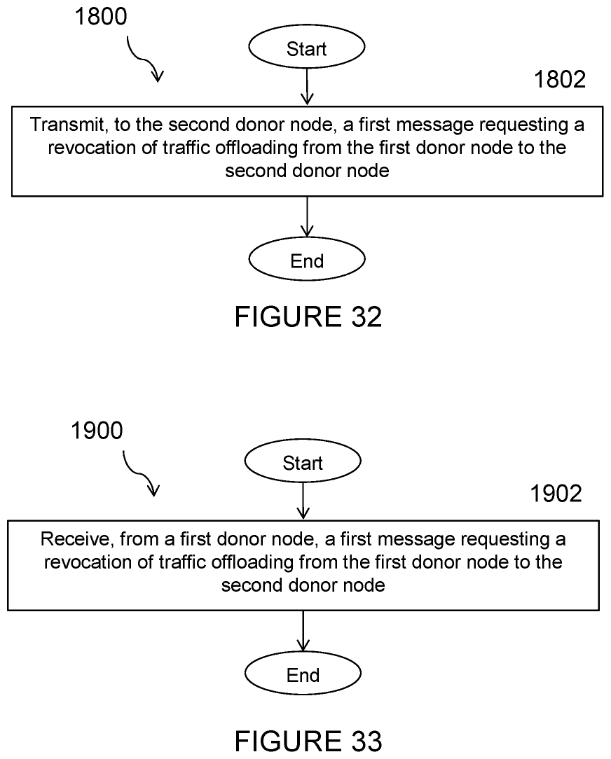

FIG. 32 illustrates a method 1800 performed by a network node 160 operating as a first donor node for a wireless device 110, according to certain embodiments. The method includes transmitting, to the second donor node 160, a first message requesting a revocation of traffic offloading from the first donor node to the second donor node, at step 1802.

According to certain embodiments, the offloaded traffic includes UL and/or DL traffic.

According to certain embodiments, a revocation of traffic offloading means a revocation of all traffic previously offloaded to the second donor node, which may include a CU1, to a second donor node, which may include a CU2.

According to a particular embodiment, the first donor node comprises a first CU for traffic offloading, anchoring for the offloaded traffic before, during and after the traffic offloading. The second donor node comprises a second CU, for traffic offloading and providing resources for routing of offloaded traffic through the network.

According to a particular embodiment, the first donor node determines that a cause for the traffic offloading to the second donor node is no longer valid. The first message requesting the revocation of the traffic offloading is transmitted to the second donor node in response to determining that the cause for the traffic offloading is no longer valid.

According to a particular embodiment, determining that the cause for the traffic offloading to the second donor node is no longer valid where this determination is based on at least one of: an expiration of a timer; a level of traffic load associated with the first donor node; a processing load associated with the first donor node; an achieved quality of service pertaining to offloaded traffic during the traffic offloading; a signal quality associated with the first donor node (i.e., link quality between the top-level node and its parent under the first donor node and the parent node under the second donor node); a signal quality associated with the second donor node; a number of backhaul radio link control channels; a number of radio bearers; a number of wireless devices attached to the first donor node; and a number of wireless devices attached to the second donor node.

According to a particular embodiment, the first donor node determines a cause for revoking the traffic offloading to the second donor nod, and the first message requesting the revocation of the traffic offloading is transmitted to the second donor node in response to determining that the cause for revoking the traffic offloading.

According to a particular embodiment, the cause for revoking the traffic offloading is based on at least one of: an expiration of a timer; a level of traffic load associated with the first donor node; a processing load associated with the first donor node; an achieved quality of service pertaining to offloaded traffic during the traffic offloading; a signal quality associated with the first donor node; a signal quality associated with the second donor node; a number of backhaul radio link control channels; a number of radio bearers; a number of wireless devices attached to the first donor node; and a number of wireless devices attached to the second donor node.

According to a particular embodiment, the first donor node receives from the second donor node an X message requesting a revocation of traffic offloading. In response to receiving from the second donor node the X message, the first donor node sends to the second donor node an acknowledgment message.

According to a particular embodiment, the first donor node receives, from the second donor node, a request for the revocation of the traffic offloading, and wherein the first message confirms traffic offloading.

According to a particular embodiment, the first donor node transmits, to a top-level IAB node, a third message comprising at least one of: at least one re-routing rule for uplink user plane traffic; an indication that a previous set of configurations is to be reactivated; a set of new configurations to be activated; and an indication that no more uplink user plane traffic is to be sent via the second donor node.

According to a particular embodiment, the top-level IAB node is a dual connected top-level node such that an IAB-Mobile Termination of the top-level IAB node is simultaneously connected to the first donor node and the second donor node.

According to a particular embodiment, a set of configurations were used by the top-level IAB node prior to the traffic offloading to the second donor node, and wherein the third message comprises an indication to reconfigure the top-level IAB node.

According to a particular embodiment, prior to the traffic offloading to the second donor node, the first donor node operates to carry a traffic load associated with a top-level IAB node. During the traffic offloading, the second donor node operates to take over the traffic load associated with the top-level IAB node. After the revocation of the traffic offloading, the first donor node operates to resume carrying the traffic load associated with the top-level IAB node.

According to a particular embodiment, the first donor node transmits traffic to and/or receiving traffic from a top-level IAB node via a parent node under the first donor node via a path that existed prior to the traffic offloading.

According to a particular embodiment, the first donor node transmits traffic to and/or receiving traffic from a top-level IAB node via a parent node under the first donor node via a path that did not exist between the top-level IAB node and the parent node prior to the traffic offloading.

According to a particular embodiment, the first donor node transmits a routing configuration to at least one ancestor node of the top-level IAB node under the first donor node. The routing configuration enables the at least one ancestor node to serve traffic to and/or from the top-level IAB node, and the routing configuration comprises at least one of: a Backhaul Adaptation Protocol routing identifier, a Backhaul Adaptation Protocol address, an Internet Protocol address, and a backhaul Radio Link Control channel identifier.

According to a particular embodiment, the first donor node receives, from the second donor node, a confirmation message indicating that traffic offloading has been revoked.

FIG. 33 illustrates a method 1900 by a network node 160 operating as a second donor node for traffic offloading for a wireless device 110, according to certain embodiments. The method includes receiving, from a first donor node, a first message requesting a revocation of traffic offloading from the first donor node to the second donor node, at step 1902.

According to certain embodiments, the offloaded traffic includes UL and/or DL traffic.

According to certain embodiments, a revocation of traffic offloading means a revocation of all traffic previously offloaded to the second donor node, which may include a CU1, to a second donor node, which may include a CU2.

According to a particular embodiment, the second donor node performs at least one action to revoke traffic offloading.

According to a particular embodiment, the first donor node comprises a first Centralized Unit, CU, for traffic offloading, anchoring for offloaded traffic, and the second donor node comprises a second CU for traffic offloading, providing resources for routing of the offloaded traffic.

According to certain embodiments, the second donor node transmits, to the first donor node, a confirmation message indicating that traffic offloading to the second donor node has been revoked.

According to certain embodiments, the first message indicates that a cause for the traffic offloading is no longer valid, and the cause is based on at least one of: an expiration of a timer; a level of traffic load associated with the first donor node; a processing load associated with the first donor node; an achieved quality of service pertaining to offloaded traffic during the traffic offloading; a signal quality associated with the first donor node; a signal quality associated with the second donor node; a number of backhaul radio link control channels; a number of radio bearers; a number of wireless devices attached to the first donor node; and a number of wireless devices attached to the second donor node.

According to certain embodiments, the second donor node transmits, to the first donor node, an X message requesting a revocation of traffic offloading, and receives, from the first donor node, an acknowledgment message.

According to certain embodiments, prior to receiving the first message, the second donor node determines a cause for revoking the traffic offloading to the second donor node and transmits, to the first donor node, a request message requesting the revocation of the traffic offloading.

According to certain embodiments, the cause for revoking the traffic offloading to the second donor node is based on at least one of: an expiration of a timer; a level of traffic load associated with the second donor node; a processing load associated with the second donor node; an achieved quality of service pertaining to offload traffic during the traffic offloading; a signal quality associated with the second donor node; a number of radio bearers; a number of backhaul radio link control channels; a number of wireless devices attached to the second donor node.

According to certain embodiments, prior to the traffic offloading to the second donor node, the first donor node operates to carry a traffic load associated with a top-level IAB node. During the traffic offloading, the second donor node operates to take over the traffic load associated with the top-level IAB node. After the revocation of the traffic offloading, the first donor node operates to resume carrying the traffic load associated with the top-level IAB node.

According to certain embodiments, the second donor node transmits, to a third network node operating as a donor DU with respect to the second network node, a fourth message commanding the third network node to add a flag to a last downlink user plane packet to indicate that the downlink user plane packet is a last packet.

### EXAMPLE EMBODIMENTS

### Group A Example Embodiments

Example A1. A method by a network node operating as a first donor node for a wireless device, the method comprising: determining that a cause for offloading traffic to a second donor node is no longer valid; transmitting, to the second donor node, a first message requesting a revocation of traffic offloading from the first donor node to the second donor node; and establishing a connection with a parent node under the first donor node.

Example A2. The method of Example Embodiment A1, wherein the first donor node comprises a source donor node and the second donor node comprises a target donor node.

Example A3. The method of any one of Example Embodiments A1 to A2, wherein the first donor node comprises a first central unit and the second donor node comprises a second central unit.

Example A4. The method of any one of Example Embodiments A1 to A3, further comprising: prior to determining that the cause for offloading traffic to the second donor node is no longer valid, determining that the cause for offloading traffic to the second node is valid, and offloading all traffic for at least a wireless device from the first donor node to the second donor node.

Example A5. The method of any one of Example Embodiments A1 to A4, wherein determining that the cause for offloading traffic to the donor node is no longer valid comprises determining that a level of traffic load in a network associated with the first donor node has dropped.

Example A6. The method of any one of Example Embodiments A1 to A5, further comprising transmitting, to a top-level node, a second message indicating that traffic offloading is revoked.

Example A7. The method of Example Embodiment A6, wherein the top-level node comprises a IAB-DU node.

Example A8a. The method of any one of Example Embodiments A6 to A7, wherein the top-level node is a dual connected top-level node such that the top-level node is simultaneously connected to the first donor node and the second donor node.

Example A8b. The method of any one of Embodiments A6 to A8a, wherein the second message comprises at least one re-routing rule for uplink user plane traffic.

Example A9. The method of any one of Example Embodiments A6 to A8b, wherein the second message indicates that no more uplink user plane traffic is to be send to the second donor node.

Example A10. The method of any one of Example Embodiments A6 to A9, wherein the second message comprises a set of configurations to be applied by the top-level node.

Example A11. The method of Example Embodiment A10, wherein the set of configurations were used by the top-level node prior to the traffic offloading to the second donor node, and wherein the second message comprises an indication to reactivate the set of configurations.

Example A12. The method of any one of Example Embodiments A6 to A11, wherein the top-level node reconnects to a parent node under the first donor node such that new user plane traffic flows via an old path that existed prior to the traffic offloading.

Example A13. The method of any one of Example Embodiments A6 to A11, wherein the top-level node reconnects to a parent node under the first donor node such that new user plane traffic flows via a new path that did not exist between the top-level node and the parent node prior to the traffic offloading.

Example A14. The method of any one of Example Embodiments A6 to A13, further comprising configuring at least one ancestor node of the top-level node under the first donor node to enable the at least one ancestor node to serve traffic towards the top-level node.

Example A15. The method of Example Embodiment A14, wherein configuring the at least one ancestor node comprises transmitting a routing configuration to the at least one ancestor node.

Example A16. The method of Example Embodiment A14, wherein the routing configuration comprises at least one of: a BAP routing ID, a BAP address, an IP address, and a backhaul RLC channel ID.

Example A17. The method of anyone of Example Embodiments A15 to A16, wherein the routing configuration is a previous configuration used prior to the traffic offloading to the second donor node.

Example A18. The method of any one of Example Embodiments A1 to A17, wherein the first message to the second donor node comprises an indication of a parent node under the first donor node that a top level node should connect.

Example A19. The method of any one of Example Embodiments A1 to A18, wherein a previous connection between the parent node and the top level node existed under the first donor node prior to traffic being offloaded to the second donor node.

Example A20. The method of any one of Example Embodiments A1 to A19, further comprising receiving, from the second donor node, a fourth message confirming the revocation of traffic offloading.

Example A21. The method of any one of Example Embodiments A1 to A20, wherein determining that the cause for offloading traffic to the second donor node is no longer valid comprises receiving a message from the second donor node that indicates a request for the revocation of the offload of traffic to the second donor node.

Example A22. The method of one of Example Embodiments A1 to A20, wherein determining that the cause for offloading traffic to the second donor node is no longer valid comprises receiving a message from the second donor node that indicates a source RAN node served by the first donor node has requested a revocation of DAPS toward a target RAN node served by the second donor node.

Example A23. The method of any one of Example Embodiments A1 to A22, wherein the first message indicates at least one identifier associated with at least one node which is to be migrated back to the first donor node.

Example A24. A network node comprising processing circuitry configured to perform any of the methods of Example Embodiments A1 to A23.

Example A25. A computer program comprising instructions which when executed on a computer perform any of the methods of Example Embodiments A1 to A23.

Example A26. A computer program product comprising computer program, the computer program comprising instructions which when executed on a computer perform any of the methods of Example Embodiments A1 to A23.

Example A27. A non-transitory computer readable medium storing instructions which when executed by a computer perform any of the methods of Example Embodiments A1 to A23.

### Group B Embodiments

Example B1. A method by a network node operating as a second donor node for traffic offloading for a wireless device, the method comprising: receiving, from a first donor node, a first message requesting a revocation of traffic offloading from the first donor node to the second donor node; based on the first message, transmitting, to a top level node, a second message indicating that the top level node is to connect to a parent node under the first donor node; and transmitting, to the first donor node, a third message confirming the revocation of the traffic offloading from the first donor node to the second donor node.

Example B2. The method of Example Embodiment B1, wherein the first donor node comprises a source donor node for traffic offloading and the second donor node comprises a target donor node for traffic offloading.

Example B3. The method of any one of Example Embodiments B1 to B2, wherein the first donor node comprises a first central unit and the second donor node comprises a second central unit.

Example B4. The method of any one of Example Embodiments B1 to B3, wherein the first message comprises an indication that a cause for offloading traffic to a second donor node is no longer valid.

Example B5. The method of any one of Example Embodiments B1 to B4, further comprising: prior to receiving the first message requesting the revocation of traffic offloading, receiving a request to initiate traffic offloading from the first donor node to the second donor node, and offloading all traffic for at least a wireless device from the first donor node to the second donor node.

Example B6. The method of any one of Example Embodiments B1 to B5, further comprising transmitting, to a top-level node, a third message indicating that traffic offloading is revoked.

Example B7. The method of Example Embodiment B6, wherein the top-level node comprises a IAB-DU node.

Example B8a. The method of any one of Example Embodiments B6 to B7, wherein the top-level node is a dual connected top-level node such that the top-level node is simultaneously connected to the first donor node and the second donor node.

Example B8b. The method of any one of Embodiments B6 to B8a, wherein the second message comprises at least one re-routing rule for uplink user plane traffic.

Example B9. The method of any one of Example Embodiments B6 to B8b, wherein the second message indicates that no more uplink user plane traffic is to be send to the second donor node.

Example B10. The method of any one of Example Embodiments B6 to B9, wherein the second message comprises a set of configurations to be applied by the top-level node.

Example B11. The method of Example Embodiment B10, wherein the set of configurations were used by the top-level node prior to the traffic offloading to the second donor node, and wherein the second message comprises an indication to reactivate the set of configurations.

Example B12. The method of any one of Example Embodiments B6 to B11, wherein the top-level node reconnects to a parent node under the first donor node such that new user plane traffic flows via an old path that existed prior to the traffic offloading.

Example B13. The method of any one of Example Embodiments B6 to B11, wherein the top-level node reconnects to a parent node under the first donor node such that new user plane traffic flows via a new path that did not exist between the top-level node and the parent node prior to the traffic offloading.

Example B14. The method of any one of Example Embodiments B6 to B13, further comprising configuring at least one ancestor node of the top-level node under the first donor node to enable the at least one ancestor node to serve traffic towards the top-level node.

Example B15. The method of Example Embodiment B14, wherein configuring the at least one ancestor node comprises transmitting a routing configuration to the at least one ancestor node.

Example B16. The method of Example Embodiment B14, wherein the routing configuration comprises at least one of: a BAP routing ID, a BAP address, an IP address, and a backhaul RLC channel ID.

Example B17. The method of anyone of Example Embodiments B15 to B16, wherein the routing configuration is a previous configuration used prior to the traffic offloading to the second donor node.

Example B18. The method of any one of Example Embodiments B1 to B17, wherein the first message from the first donor node comprises an indication of a parent node under the first donor node that a top level node should connect.

Example B19. The method of any one of Example Embodiments B1 to B18, wherein a previous connection between the parent node and the top level node existed under the first donor node prior to traffic being offloaded to the second donor node.

Example B20. The method of any one of Example Embodiments B1 to B20, wherein, prior to receiving the first message, the method comprises: determining that offloading traffic to the second donor node is no longer valid; and transmitting, to the first donor node, a message comprising a request for the revocation of the traffic offloading.

Example B21. The method of Example Embodiment B20, wherein determining that offloading traffic to the second donor node is no longer valid comprises at least one of: determining that the second donor node can no longer serve the offloaded traffic; determining that a signal quality between a top-level node and an old parent node is sufficiently good to reestablish a link; and determining that a period of time for traffic offloading has expired.

Example B22. The method of Example Embodiment B20, wherein determining that offloading traffic to the second donor node is no longer valid comprises determining that a source RAN node or a target RAN node has requested a revocation of DAPS toward the target RAN node, wherein the source RAN node is served by the first donor node and wherein the target RAN node is served by the second donor node.

Example B23. The method of any one of Example Embodiments B1 to B22, wherein the first message indicates at least one identifier associated with at least one node which is to be migrated back to the first donor node.

Example B24. A network node comprising processing circuitry configured to perform any of the methods of Example Embodiments B1 to B23.

Example B25. A computer program comprising instructions which when executed on a computer perform any of the methods of Example Embodiments B1 to B23.

Example B26. A computer program product comprising computer program, the computer program comprising instructions which when executed on a computer perform any of the methods of Example Embodiments B1 to B23.

Example B27. A non-transitory computer readable medium storing instructions which when executed by a computer perform any of the methods of Example Embodiments B1 to B23.

### Group C Example Embodiments

Example C1. A method by a network node operating as a first donor node for a wireless device, the method comprising: determining that a cause for offloading traffic to a second donor node is no longer valid; transmitting, to a top-level node, a message indicating that traffic offloading is revoked; and establishing a connection with a parent node under the first donor node and the top-level node.

Example C2. The method of Example Embodiment C1, wherein the first donor node comprises a source donor node and the second donor node comprises a target donor node.

Example C3. The method of any one of Example Embodiments C1 to C2, wherein the first donor node comprises a first central unit and the second donor node comprises a second central unit.

Example C4. The method of any one of Example Embodiments C1 to C3, wherein the top-level node comprises a IAB-DU node.

Example C5. The method of any one of Example Embodiments C1 to C4, wherein the top-level node is a dual connected top-level node such that the top-level node is simultaneously connected to the first donor node and the second donor node.

Example C6. The method of any one of Embodiments C1 to C5, wherein the first message comprises at least one re-routing rule for uplink user plane traffic.

Example C7. The method of any one of Example Embodiments C1 to C6, wherein the first message indicates that no more uplink user plane traffic is to be send to the second donor node.

Example C8. The method of any one of Example Embodiments C1 to C7, wherein the first message comprises a set of configurations to be applied by the top-level node.

Example C9. The method of Example Embodiment C8, wherein the set of configurations were used by the top-level node prior to the traffic offloading to the second donor node, and wherein the first message comprises an indication to reactivate the set of configurations.

Example C10. The method of any one of Example Embodiments C1 to C9, wherein the top-level node reconnects to the parent node under the first donor node such that new user plane traffic flows via an old path that existed prior to the traffic offloading.

Example C11. The method of any one of Example Embodiments C1 to C9, wherein the top-level node reconnects to the parent node under the first donor node such that new user plane traffic flows via a new path that did not exist between the top-level node and the parent node prior to the traffic offloading.

Example C12. The method of any one of Example Embodiments C1 to C11, further comprising configuring at least one ancestor node of the top-level node under the first donor node to enable the at least one ancestor node to serve traffic towards the top-level node.

Example C13. The method of Example Embodiment C12, wherein configuring the at least one ancestor node comprises transmitting a routing configuration to the at least one ancestor node.

Example C14. The method of Example Embodiment C13, wherein the routing configuration comprises at least one of: a BAP routing ID, a BAP address, an IP address, and a backhaul RLC channel ID.

Example C15. The method of any one of Example Embodiments C13 to C14, wherein the routing configuration is a previous configuration used prior to the traffic offloading to the second donor node.

Example C16. The method of Example Embodiments C1 to C15, wherein prior to determining that the cause for offloading traffic to the second donor node is no longer valid, the method further comprises: determining that the cause for offloading traffic to the second node is valid, and offloading all traffic for at least a wireless device from the first donor node to the second donor node.

Example C17. The method of any one of Example Embodiments C1 to C16, wherein determining that the cause for offloading traffic to the donor node is no longer valid comprises determining that a level of traffic load in a network associated with the first donor node has dropped.

Example C18. The method of any one of Example Embodiments C1 to C17, further comprising: transmitting, to the second donor node, a second message requesting a revocation of traffic offloading from the first donor node to the second donor node.

Example C19. The method of Example Embodiment C18, wherein the second message to the second donor node comprises an indication of a parent node under the first donor node that a top level node should connect.

Example C20. The method of any one of Example Embodiments C18 to C19, further comprising receiving, from the second donor node, a third message confirming the revocation of traffic offloading.

Example C21. The method of any one of Example Embodiments C18 to C20, wherein the second message indicates at least one identifier associated with at least one node which is to be migrated back to the first donor node.

Example C22. The method of any one of Example Embodiments C1 to C21, wherein determining that the cause for offloading traffic to the second donor node is no longer valid comprises receiving a message from the second donor node that indicates a request for the revocation of the offload of traffic to the second donor node.

Example C23. The method of one of Example Embodiments C1 to C22, wherein determining that the cause for offloading traffic to the second donor node is no longer valid comprises receiving a message from the second donor node that indicates a source RAN node served by the first donor node has requested a revocation of DAPS toward a target RAN node served by the second donor node.

Example C24. The method of any one of Example Embodiments C1 to C23, wherein a previous connection between the parent node and the top level node existed under the first donor node prior to traffic being offloaded to the second donor node.

Example C25. A network node comprising processing circuitry configured to perform any of the methods of Example Embodiments C1 to C24.

Example C26. A computer program comprising instructions which when executed on a computer perform any of the methods of Example Embodiments C1 to C24.

Example C27. A computer program product comprising computer program, the computer program comprising instructions which when executed on a computer perform any of the methods of Example Embodiments C1 to C24.

Example C28. A non-transitory computer readable medium storing instructions which when executed by a computer perform any of the methods of Example Embodiments C1 to C24.

### Group D Example Embodiments

Example D1. A method by a network node operating as a top-level node under a first donor node, the method comprising: receiving, from the first donor node, a message indicating that traffic offloading is revoked; and establishing a connection with a parent node under the first donor node and the top-level node.

Example D2. The method of Example Embodiment D1, wherein the first donor node comprises a source donor node with respect to a wireless device and a second donor node comprises a target donor node for traffic offloading with respect to the wireless device.

Example D3. The method of Example Embodiment D2, wherein the first donor node comprises a first central unit and the second donor node comprises a second central unit.

Example D4. The method of any one of Example Embodiments D1 to D3, wherein the top-level node comprises an IAB-DU node.

Example D5. The method of any one of Example Embodiments D2 to D4, wherein the top-level node is a dual connected top-level node such that the top-level node is simultaneously connected to the first donor node and the second donor node.

Example D6. The method of any one of Embodiments D1 to D5, wherein the first message comprises at least one re-routing rule for uplink user plane traffic.

Example D7. The method of any one of Example Embodiments D1 to D6, wherein the first message indicates that no more uplink user plane traffic is to be send to the second donor node.

Example D8. The method of any one of Example Embodiments D1 to D7, wherein the first message comprises a set of configurations to be applied by the top-level node.

Example D9. The method of Example Embodiment D8, wherein the set of configurations were used by the top-level node prior to the traffic offloading to the second donor node, and wherein the first message comprises an indication to reactivate the set of configurations.

Example D10. The method of any one of Example Embodiments D1 to D9, wherein establishing the connection with the parent node comprises reconnecting to the parent node under the first donor node such that new user plane traffic flows via an old path that existed prior to the traffic offloading.

Example D11. The method of any one of Example Embodiments D1 to D9, wherein establishing the connection with the parent node comprises connecting to the parent node such that new user plane traffic flows via a new path that did not exist between the top-level node and the parent node prior to the traffic offloading.

Example D12. The method of any one of Example Embodiments D1 to D11, further comprising configuring at least one ancestor node under the top-level node and the first donor node to enable the at least one ancestor node to serve traffic towards the top-level node.

Example D13. The method of Example Embodiment D12, wherein configuring the at least one ancestor node comprises transmitting a routing configuration to the at least one ancestor node.

Example D14. The method of Example Embodiment D13, wherein the routing configuration comprises at least one of: a BAP routing ID, a BAP address, an IP address, and a backhaul RLC channel ID.

Example D15. The method of any one of Example Embodiments D13 to D14, wherein the routing configuration is a previous configuration used prior to the traffic offloading to the second donor node.

Example D16. The method of any one of Example Embodiments D1 to D15, wherein a previous connection between the parent node and the top level node existed under the first donor node prior to traffic being offloaded to the second donor node.

Example D17. A network node comprising processing circuitry configured to perform any of the methods of Example Embodiments D1 to D16.

Example D18. A computer program comprising instructions which when executed on a computer perform any of the methods of Example Embodiments D1 to D16.

Example D19. A computer program product comprising computer program, the computer program comprising instructions which when executed on a computer perform any of the methods of Example Embodiments D1 to D16.

Example D20. A non-transitory computer readable medium storing instructions which when executed by a computer perform any of the methods of Example Embodiments D1 to D16.

### Group E Example Embodiments

Example E1. A method by a network node operating as a second donor node for a wireless device, the method comprising: transmitting, to a first donor node, a first message requesting a revocation of traffic offloading from the first donor node to the second donor node.

Example E2. The method of Example Embodiment E1, wherein: the first donor node comprises a first Centralized Unit, CU, for traffic offloading, anchoring for offloaded traffic, and the second donor node comprises a second CU for traffic offloading, providing resources for routing of the offloaded traffic.

Example E3. The method of any one of Example Embodiments E1 to E2, further comprising: determining a cause for revoking the traffic offloading to the second donor node, and wherein the first message requesting the revocation of the traffic offloading is transmitted to the first donor node in response to determining the cause for revoking the traffic offloading.

Example E4. The method of Example Embodiment E3, wherein the cause for revoking the traffic offloading to the second donor node is based on at least one of: an expiration of a timer; a level of traffic load associated with the second donor node; a processing load associated with the second donor node; an achieved quality of service pertaining to offload traffic during the traffic offloading; a signal quality associated with the second donor node; a number of radio bearers; a number of backhaul radio link control channels; a number of wireless devices attached to the second donor node.

Example E5. The method of any one of Example Embodiments E1 to E4, wherein: prior to the traffic offloading to the second donor node, the first donor node operates to carry a traffic load associated with a top-level IAB node, during the traffic offloading, the second donor node operates to take over the traffic load associated with the top-level IAB node, and after the revocation of the traffic offloading, the first donor node operates to resume carrying the traffic load associated with the top-level IAB node.

Example E6. The method of any one of Example Embodiments E1 to E5, further comprising receiving, from the first donor node, a confirmation message indicating that traffic offloading has been revoked.

Example E7. A network node comprising processing circuitry configured to perform any of the methods of Example Embodiments E1 to E6.

### Group F Example Embodiments

Example F1. A method by a network node operating as a first donor node for traffic offloading for a wireless device, the method comprising: receiving, from a second donor node, a first message requesting a revocation of traffic offloading from the first donor node to the second donor node.

Example F2. The method of Example Embodiment F1, wherein: the first donor node comprises a first Centralized Unit, CU, for traffic offloading, anchoring for offloaded traffic, and the second donor node comprises a second CU for traffic offloading, providing resources for routing of the offloaded traffic.

Example F3. The method of any one of Example Embodiments F1 to F2 further comprising: based on the first message, transmitting, to a top level IAB node, a second message indicating that the top level IAB node is to connect to a parent node under the first donor node.

Example F4. The method of any one of Example Embodiments F1 to F3, further comprising: transmitting, to the second donor node, a confirmation message indicating that traffic offloading to the second donor node has been revoked.

Example F5. The method of any one of Example Embodiments F1 to F4, wherein the first message comprises an indication of a cause for revoking traffic offloading to the second donor node.

Example F6. The method of Example Embodiment F5, wherein the cause for revoking the traffic offloading to the second donor node is based on at least one of: an expiration of a timer; a level of traffic load associated with the second donor node; a processing load associated with the second donor node; an achieved quality of service pertaining to offload traffic during the traffic offloading; a signal quality associated with the second donor node; a number of radio bearers; a number of backhaul radio link control channels; a number of wireless devices attached to the second donor node.

Example F7. The method of any one of Example Embodiments F1 to F6, further comprising transmitting, to a top-level IAB node, a third message comprising at least one of: at least one re-routing rule for uplink user plane traffic; an indication that a previous set of configurations is to be reactivated; a set of new configurations to be activated; and an indication that no more uplink user plane traffic is to be sent via the second donor node.

Example F8. The method of Example F7, wherein the top-level IAB node is a dual connected top-level node such that an IAB-Mobile Termination of the top-level node is simultaneously connected to the first donor node and the second donor node.

Example F9. The method of any one of Example Embodiments F7 to F8, wherein: prior to the traffic offloading to the second donor node, the first donor node operates to carry a traffic load associated with the top-level IAB node, during the traffic offloading, the second donor node operates to take over the traffic load associated with the top-level IAB node, and after the revocation of the traffic offloading, the first donor node operates to resume carrying the traffic load associated with the top-level IAB node.

Example F10. The method of any one of Example Embodiments F1 to F9, wherein the set of configurations were used by the top-level node prior to the traffic offloading to the second donor node, and wherein the third message comprises an indication to reconfigure the top-level IAB node.

Example F11. The method of any one of Example Embodiments F1 to F10, further comprising transmitting traffic to and/or receiving traffic from a top-level IAB node via a parent node under the first donor node via a path that existed prior to the traffic offloading.

Example F12. The method of any one of Example Embodiments F1 to F11, further comprising transmitting traffic to and/or receiving traffic from a top-level IAB node via a parent node under the first donor node via a path that did not exist between the top-level IAB node and the parent node prior to the traffic offloading.

Example F13. A network node comprising processing circuitry configured to perform any of the methods of Example Embodiments F1 to F12.

### Group G Example Embodiments

Example G1. A network node comprising: processing circuitry configured to perform any of the steps of any of the Group A, B, C, D, E, and F Example Embodiments; power supply circuitry configured to supply power to the wireless device.

Example G2. A communication system including a host computer comprising: processing circuitry configured to provide user data; and a communication interface configured to forward the user data to a cellular network for transmission to a wireless device, wherein the cellular network comprises a network node having a radio interface and processing circuitry, the network node's processing circuitry configured to perform any of the steps of any of the Group A, B, C, D, E, and F Example Embodiments.

Example G3. The communication system of the pervious embodiment further including the network node.

Example G4. The communication system of the previous 2 embodiments, further including the wireless device, wherein the wireless device is configured to communicate with the network node.

Example G5. The communication system of the previous 3 embodiments, wherein: the processing circuitry of the host computer is configured to execute a host application, thereby providing the user data; and the wireless device comprises processing circuitry configured to execute a client application associated with the host application.

Example G6. A method implemented in a communication system including a host computer, a network node and a wireless device, the method comprising: at the host computer, providing user data; and at the host computer, initiating a transmission carrying the user data to the wireless device via a cellular network comprising the network node, wherein the network node performs any of the steps of any of the Group A, B, C, D, E, and F Example Embodiments.

Example G7. The method of the previous embodiment, further comprising, at the network node, transmitting the user data.

Example G8. The method of the previous 2 embodiments, wherein the user data is provided at the host computer by executing a host application, the method further comprising, at the wireless device, executing a client application associated with the host application.

Example G9. A wireless device configured to communicate with a network node, the wireless device comprising a radio interface and processing circuitry configured to performs the of the previous 3 embodiments.

Example G10. A communication system including a host computer comprising a communication interface configured to receive user data originating from a transmission from a wireless device to a network node, wherein the network node comprises a radio interface and processing circuitry, the network node's processing circuitry configured to perform any of the steps of any of the Group A, B, C, D, E, and F Example Embodiments.

Example G11. The communication system of the previous embodiment further including the network node.

Example G12. The communication system of the previous 2 embodiments, further including the wireless device, wherein the wireless device is configured to communicate with the network node.

Example G13. The communication system of the previous 3 embodiments, wherein: the processing circuitry of the host computer is configured to execute a host application; the wireless device is configured to execute a client application associated with the host application, thereby providing the user data to be received by the host computer.

Example G14. The method of any of the previous embodiments, wherein the network node comprises a base station.

Example G15. The method of any of the previous embodiments, wherein the wireless device comprises a user equipment (UE).

1. A method performed by a network node operating as a first donor node for a wireless device, the method comprising:
transmitting, to the second donor node, a first message requesting a revocation of traffic offloading from the first donor node to the second donor node.

2. The method of claim 1, wherein:
the first donor node comprises a first Centralized Unit, CU, for traffic offloading, anchoring for the offloaded traffic, and
the second donor node comprises a second CU, for traffic offloading, providing resources for routing of offloaded traffic.

3. The method of claim 1, further comprising:
determining that a cause for the traffic offloading to the second donor node is no longer valid, and
wherein the first message requesting the revocation of the traffic offloading is transmitted to the second donor node in response to determining that the cause for the traffic offloading is no longer valid.

4. The method of claim 3, wherein determining that the cause for the traffic offloading to the second donor node is no longer valid where this determination is based on at least one of:
an expiration of a timer;
a level of traffic load associated with the first donor node;
a processing load associated with the first donor node;
an achieved quality of service pertaining to offloaded traffic during the traffic offloading;
a signal quality associated with the first donor node;
a signal quality associated with the second donor node;
a number of backhaul radio link control channels;
a number of radio bearers;
a number of wireless devices attached to the first donor node; and
a number of wireless devices attached to the second donor node.

5. The method of claim 1, further comprising:
determining a cause for revoking the traffic offloading to the second donor nod, and
wherein the first message requesting the revocation of the traffic offloading is transmitted to the second donor node in response to determining that the cause for revoking the traffic offloading.

6. The method of claim 5, wherein the cause for revoking the traffic offloading is based on at least one of:
an expiration of a timer;
a level of traffic load associated with the first donor node;
a processing load associated with the first donor node;
an achieved quality of service pertaining to offloaded traffic during the traffic offloading;
a signal quality associated with the first donor node;
a signal quality associated with the second donor node;
a number of backhaul radio link control channels;
a number of radio bearers;
a number of wireless devices attached to the first donor node; and
a number of wireless devices attached to the second donor node.

7. The method of claim 1, further comprising:
receiving from the second donor node an X message requesting a revocation of traffic offloading, and
in response to receiving from the second donor node the X message, sending to the second donor node an acknowledgment message.

8. The method of claim 1, further comprising receiving, from the second donor node, a request for the revocation of the traffic offloading, and wherein the first message confirms traffic offloading.

9. The method of claim 1, further comprising transmitting, to a top-level Integrated Access and Backhaul, IAB, node, a third message comprising at least one of:
at least one re-routing rule for uplink user plane traffic;
an indication that a previous set of configurations is to be reactivated;
a set of new configurations to be activated; and
an indication that no more uplink user plane traffic is to be sent via the second donor node.

10. The method of claim 9, wherein the top-level IAB node is a dual connected top-level node such that an IAB-Mobile Termination of the top-level IAB node is simultaneously connected to the first donor node and the second donor node.

11. The method of claim 9, wherein a set of configurations were used by the top-level IAB node prior to the traffic offloading to the second donor node, and wherein the third message comprises an indication to reconfigure the top-level IAB node.

12. The method of claim 1, wherein:
prior to the traffic offloading to the second donor node, the first donor node operates to carry a traffic load associated with a top-level IAB node,
during the traffic offloading, the second donor node operates to take over the traffic load associated with the top-level IAB node, and
after the revocation of the traffic offloading, the first donor node operates to resume carrying the traffic load associated with the top-level IAB node.

13. The method of claim 1, further comprising transmitting traffic to and/or receiving traffic from a top-level IAB node via a parent node under the first donor node via a path that existed prior to the traffic offloading.

14. The method of claim 1, further comprising transmitting traffic to and/or receiving traffic from a top-level IAB node via a parent node under the first donor node via a path that did not exist between the top-level IAB node and the parent node prior to the traffic offloading.

15. The method of claim 13, further comprising transmitting a routing configuration to at least one ancestor node of the top-level IAB node under the first donor node, the routing configuration enabling the at least one ancestor node to serve traffic to and/or from the top-level IAB node, the routing configuration comprising at least one of a Backhaul Adaptation Protocol routing identifier, a Backhaul Adaptation Protocol address, an Internet Protocol address, and a backhaul Radio Link Control channel identifier.

16. The method of any one of claim 1, further comprising receiving, from the second donor node, a confirmation message indicating that traffic offloading has been revoked.

17. A method by a network node operating as a second donor node for traffic offloading for a wireless device, the method comprising:
receiving, from a first donor node, a first message requesting a revocation of traffic offloading from the first donor node to the second donor node.

18. The method of claim 17, further comprising performing at least one action to revoke traffic offloading.

19. The method of claim 17, wherein:
the first donor node comprises a first Centralized Unit, CU, for traffic offloading, anchoring for offloaded traffic, and
the second donor node comprises a second CU for traffic offloading, providing resources for routing of the offloaded traffic.

20. The method of claim 17, further comprising:
transmitting, to the first donor node, a confirmation message indicating that traffic offloading to the second donor node has been revoked.

21. The method of claim 17, wherein the first message indicates that a cause for the traffic offloading is no longer valid, wherein the cause is based on at least one of:
an expiration of a timer;
a level of traffic load associated with the first donor node;
a processing load associated with the first donor node;
an achieved quality of service pertaining to offloaded traffic during the traffic offloading;
a signal quality associated with the first donor node;
a signal quality associated with the second donor node;
a number of backhaul radio link control channels;
a number of radio bearers;
a number of wireless devices attached to the first donor node; and
a number of wireless devices attached to the second donor node.

22. The method of claim 17, further comprising:
transmitting, to the first donor node, an X message requesting a revocation of traffic offloading, and
receiving, from the first donor node, an acknowledgment message.

23. The method of claim 17, wherein prior to receiving the first message the method further comprises:
determining a cause for revoking the traffic offloading to the second donor node; and
transmitting, to the first donor node, a request message requesting the revocation of the traffic offloading.

24. (canceled)

25. The method of claim 17, wherein:
prior to the traffic offloading to the second donor node, the first donor node operates to carry a traffic load associated with a top-level Integrated Access and Backhaul, IAB, node,
during the traffic offloading, the second donor node operates to take over the traffic load associated with the top-level IAB node, and
after the revocation of the traffic offloading, the first donor node operates to resume carrying the traffic load associated with the top-level IAB node.

26. The method of claim 17, further comprising transmitting, to a third network node operating as a donor DU with respect to the second network node, a fourth message commanding the third network node to add a flag to a last downlink user plane packet to indicate that the downlink user plane packet is a last packet.

27. (canceled)

28. (canceled)
